(19) United States
(12) Patent Application Publication
(10) Pub. No.: US 2021/0243281 A1
(43) Pub. Date: Aug. 5, 2021

(54) SYSTEM AND METHOD FOR FACILITATING DATA COMMUNICATION OF A TRUSTED EXECUTION ENVIRONMENT

(71) Applicant: City University of Hong Kong, Kowloon (HK)

(72) Inventors: Huayi Duan, Kowloon (HK); Cong Wang, Kowloon (HK)

(21) Appl. No.: 16/782,151

(22) Filed: Feb. 5, 2020

(51) Int. Cl. H04L 29/06; H04L 12/801; H04L 12/26; H04L 1/00; H04W 88/16

(52) U.S. Cl. CPC H04L 69/22; H04L 69/16; H04W 88/16; H04L 43/106; H04L 1/008; H04L 47/10

(57) ABSTRACT

A computer-implemented method, and a related system, for facilitating data communication of a trusted execution environment. The method includes: processing a plurality of data packets to form a data stream including the plurality of data packets. Each data packet includes respective metadata. The data stream is a single continuous data stream in application-layer such that a boundary between two adjacent packets are not easily identifiable. The method also includes transmitting the data stream to or from a network interface module for the trusted execution environment.

### TECHNICAL FIELD

The invention relates to computer-implemented technologies, in particular systems and methods for facilitating data communication of a trusted execution environment (e.g., an enclave). The invention also relates to a network interface module for facilitating data communication of a trusted execution environment (e.g., an enclave).

### BACKGROUND

Middleboxes are networking devices that undertake critical network functions for performance, connectivity, and security, and they underpin the infrastructure of modern computer networks. Middleboxes can be hardware-based (a box-like device) or software-based (e.g., operated at least partly virtually on a server).

Recently, these exists a paradigm shift of migrating software-based middleboxes (middlebox modules, e.g., virtual network functions) to professional service providers, e.g., public cloud, for the promising security, scalability, and management benefits. According to Zscaler Inc., petabytes of traffic are now routed daily to Zscaler's cloud-based security platform for middlebox processing, and it is expected that such traffic will continue to increase. Thus, the question on how end users can be assured that their private information buried in the traffic is not unauthorized-ly leaked while being processed becomes increasingly important.

To date, a number of approaches have been proposed to address this security problem associated with software-based middleboxes. These approaches can be classified as software-centric or hardware-assisted. Software-centric solutions often rely on tailored cryptographic schemes. They are advantageous in providing provable security without hardware assumption, but are often limited in functionality and sometimes inferior in performance. On the other hand, hardware-assisted solutions move middleboxes into a trusted execution environment. These hardware-assisted solutions provide generally better functionality and performance than software-centric solutions.

Against this background, most existing data communication network designs consider the protection of only application payloads while redirecting traffic to remote middleboxes. In other words, few if any of them consider the protection of traffic metadata. Significantly, however, such metadata is information-rich and highly exploitable. In some applications, by simply exploiting metadata such as the packet size, count, and timing, various sophisticated traffic analysis attacks can be performed. These attacks may extract supposedly encrypted application contents such as website objects, VoIP conversations, streaming videos, instant messages, and user activities, by simply analyzing the distributions of metadata. As metadata may be obtained by an adversary who can sniff traffic anywhere on the transmission path, aggregating large amount of user traffic to the middlebox service provider creates a unique vantage point for traffic analysis (by the adversary), because of the much enlarged datasets for correlating information and performing statistical inference.

There is a need to tackle, address, alleviate, or eliminate one or more the above problems, or more generally, to facilitate data communication of a trusted execution environment (i.e., including but not limited to middlebox applications).

### SUMMARY OF THE INVENTION

In accordance with a first aspect of the invention, there is provided a computer-implemented method for facilitating data communication of a trusted execution environment. The method includes: processing a plurality of data packets, each including respective metadata, to form a data stream that includes the plurality of data packets. The data stream is a single continuous data stream in application-layer. The method also includes transmitting the data stream to or from a network interface module for the trusted execution environment. The processing may be performed by the network interface module (if the data stream is transmitted from the network interface module), or by a gateway (e.g., a remote gateway remote from the network interface module) in communication with the network interface module (if the data stream is transmitted to the network interface module).

In one embodiment of the first aspect, the data stream is encrypted. The encryption may be performed by the network interface module, by a gateway in communication with the network interface module (e.g., a remote gateway remote from the network interface module and/or remote from the trusted execution environment).

In one embodiment of the first aspect, the metadata of each respective data packet includes one or more or all of: packet size, packet count, and/or timestamp. In one embodiment of the first aspect, each of the data packets further includes application payload and one or more packet headers. The application payload may include a L4 payload with application content. The one or more packet headers may include one or more or all of: a L2 header, a L3 header, and a L4 header. For example, the one or more packet headers include information associated with one or more or all of: IP address, port number, and/or TCP/IP flag.

In one embodiment of the first aspect, processing the plurality of data packets includes encoding the plurality of data packets.

In one embodiment of the first aspect, processing the plurality of data packets includes packing the plurality of data packets back-to-back to form the data stream. The back-to-back packing may be direct (nothing in between two adjacent packets) or indirect (with other data in between two adjacent packets).

In one embodiment of the first aspect, transmitting the data stream includes: transmitting the data stream from a gateway to the network interface module via a communication channel arranged between the gateway and the network interface module. Additionally, alternatively, or optionally, transmitting the data stream includes: transmitting the data stream from the network interface module to a gateway via a communication channel arranged between the gateway and the network interface module. The gateway may be a trusted gateway remote from the network interface module and/or remote from the trusted execution environment. The communication channel may be a secure communication channel, such as a Transport Layer Security (TLS) communication channel.

In one embodiment of the first aspect, the method also includes transmitting one or more heartbeat packets from the gateway to the network interface module via the communication channel. The initiation of the transmission may be by the network interface module or by the gateway.

In one embodiment of the first aspect, the trusted execution environment includes a middlebox module implemented in the trusted execution environment, and the network interface module is arranged to be in data communication with the middlebox module (e.g., so that the data packets in the received data stream can be accessed or otherwise used by the middlebox module). The network interface module may be the only data communication interface of the middlebox module, i.e., all external data packet communication with the middlebox module must be performed through the network interface module. The network interface module may be initialized or arranged at least partly (e.g., partly or completely) in the trusted execution environment. The middlebox module may be initialized or arranged completely in the trusted execution environment. In one example, the trusted execution environment includes or is a Software Guard Extension (SGX) enclave. The middlebox module may be a stateful middlebox module.

The trusted execution environment may include a memory environment and/or a processing environment. In one embodiment of the first aspect, the trusted execution environment is initialized or provided using one or more processors. In the example in which the trusted execution environment includes or is an SGX enclave, the trusted execution environment is initialized or provided using one or more processors that support SGX instructions such as Intel® SGX instructions. Optionally, the module(s) and component(s) in the trusted execution environment, such as the middlebox module and the network interface module, may be initialized or provided at least partly (e.g., partly or completely) using the one or more processors, e.g., one or more processors that support SGX instructions such as Intel® SGX instructions.

In one embodiment of the first aspect, the network interface module includes a core driver arranged in the trusted execution environment, the core driver is arranged to receive and process the data stream. The core driver may also be arranged to transmit data stream, e.g., to the gateway via the communication channel. The core driver may be arranged to establish the communication channel, store session keys, and/or control and coordinate networking, encoding, and cryptographic operations associated with the trusted execution environment.

In one embodiment of the first aspect, the core driver is further arranged to maintain a clock module in the trusted execution environment. The clock module may be part of the network interface module. The clock of the clock module may substantially correspond to a clock of the gateway, e.g., optionally with offset, delay, etc.

In one embodiment of the first aspect, the method also includes including a timestamp in each of the data packets prior to transmission of the data stream to the network interface module. The inclusion of the timestamp may be part of the processing step for forming the data stream.

In one embodiment of the first aspect, the method also includes comparing, using the core driver, the timestamp in the received data packet with a clock in the clock module; and updating the clock module based on the comparison (e.g., update if needed).

In one embodiment of the first aspect, the network interface module further includes: a poll driver arranged in the trusted execution environment, and operably connected with the core driver and with the middlebox module. The poll driver is arranged to enable the middlebox module to access data packets in the data stream received at the network interface module.

In one embodiment of the first aspect, the network interface module further includes: a receiver repository arranged in the trusted execution environment and arranged between the core driver and the poll driver, the receiver repository is arranged to hold packet data (e.g., extracted from the received data stream) received at the network interface module, e.g., from the gateway via the communication channel. The network interface module also includes a transmission repository arranged in the trusted execution environment and arranged between the core driver and the poll driver. The transmission repository is arranged to hold packet data to be transmitted (optionally to be processed) out of the network interface module, e.g., to the gateway via the communication channel. The receiver repository and the transmission repository may be separate or at least partly combined. The receiver repository may have a repository size (number of entries) from 150 to 350, from 200 to 300, about 250, or 256. The transmission repository may have a repository size (number of entries) from 150 to 350, from 200 to 300, about 250, or 256. In other embodiments, the receiver repository may have a different (larger or smaller) repository size (number of entries). In other embodiments, the transmission repository may have a different (larger or smaller) repository size (number of entries). In one embodiment of the first aspect, the receiver repository and the transmission repository each has a respective ring-like architecture. The ring-like architecture may be lock-free.

In one embodiment of the first aspect, the poll driver is arranged to pull packet data into the receiver repository and to push data into the transmission repository.

In one embodiment of the first aspect, the poll driver is arranged to operate in a blocking mode, in which a packet is guaranteed to be read or written, and a non-blocking mode. In the non-blocking mode, a packet may not be read or written for each call to the poll driver.

In one embodiment of the first aspect, the method also includes synchronizing the receiver repository and the transmission repository. The synchronization may relate to the timing of operation.

In one embodiment of the first aspect, the network interface module further includes: a buffer module arranged outside the trusted execution environment and arranged between the core driver and the gateway. The buffer module is arranged to hold a plurality of records (outside the trusted execution environment). The records may be TLS records. The batch size may be from 5 to 15, around 10, or 10. In other embodiments, the batch size can be different (larger or smaller). The packet size may be 64 bytes, 128 bytes, 256 bytes, 512 bytes, 1024 bytes, or even more. In other embodiments, the packet size can be different (larger or smaller). In the embodiment with the buffer module, the network interface module is only partly arranged in the trusted execution environment.

In one embodiment of the first aspect, the network interface module can provide an input/output performance at least in the order of Gbps.

In accordance with a second aspect of the invention, there is provided a computer-implemented system for facilitating data communication of a trusted execution environment. The system includes: means for processing a plurality of data packets, each including respective metadata, to form a data stream including the plurality of data packets, the data stream being a single continuous data stream in application-layer; and means for transmitting the data stream to or from a network interface module for the trusted execution environment. The processing means and the transmission means may be provided by the network interface module (if the data stream is transmitted from the network interface module), or by a gateway (e.g., a remote gateway remote from the network interface module) in communication with the network interface module (if the data stream is transmitted to the network interface module).

In one embodiment of the second aspect, the data stream is encrypted. The encryption may be performed by an encryption means provided by the network interface module, or by a gateway in communication with the network interface module (e.g., a remote gateway remote from the network interface module and/or remote from the trusted execution environment).

In one embodiment of the second aspect, the metadata of each respective data packet includes one or more or all of: packet size, packet count, and/or timestamp. In one embodiment of the second aspect, each of the data packets further includes application payload and one or more packet headers. The application payload may include a L4 payload with application content. The one or more packet headers may include one or more or all of: a L2 header, a L3 header, and a L4 header. For example, the one or more packet headers include information associated with one or more or all of: IP address, port number, and/or TCP/IP flag.

In one embodiment of the second aspect, the processing means include means for encoding the plurality of data packets.

In one embodiment of the second aspect, the processing means include means for packing the plurality of data packets back-to-back to form the data stream. The back-to-back packing may be direct (nothing in between two adjacent packets) or indirect (with other data in between two adjacent packets).

In one embodiment of the second aspect, the transmission means is arranged to: transmit the data stream from a gateway to the network interface module via a communication channel arranged between the gateway and the network interface module. Alternatively, or optionally, the transmission means is arranged to: transmit the data stream from the network interface module to a gateway via a communication channel arranged between the gateway and the network interface module. The gateway may be a trusted gateway remote from the network interface module and/or remote from the trusted execution environment. The communication channel may be a secure communication channel, such as a Transport Layer Security (TLS) communication channel.

In one embodiment of the second aspect, the system also includes means for transmitting one or more heartbeat packets from the gateway to the network interface module via the communication channel. The initiation of the transmission may be by the network interface module or by the gateway. The means for transmitting heartbeat packet(s) may be the means for transmitting the data stream. Or they may be separate means.

In one embodiment of the second aspect, the trusted execution environment includes a middlebox module implemented in the trusted execution environment, and the network interface module is arranged to be in data communication with the middlebox module (e.g., so that the data packets in the received data stream can be accessed or otherwise used by the middlebox module). The network interface module may be the only data communication interface of the middlebox module, i.e., all external data packet communication with the middlebox module must be performed through the network interface module. The network interface module may be initialized or arranged at least partly (e.g., partly or completely) in the trusted execution environment. The middlebox module may be initialized or arranged completely in the trusted execution environment. In one example, the trusted execution environment includes or is a Software Guard Extension (SGX) enclave. The middlebox module may be a stateful middlebox module.

The trusted execution environment may include a memory environment and/or a processing environment. In one embodiment of the second aspect, the trusted execution environment is initialized or provided using one or more processors. In the example in which the trusted execution environment includes or is an SGX enclave, the trusted execution environment is initialized or provided using one or more processors that support SGX instructions such as Intel® SGX instructions. Optionally, the module(s) and component(s) in the trusted execution environment, such as the middlebox module and the network interface module, may be initialized or provided at least partly (e.g., partly or completely) using the one or more processors, e.g., one or more processors that support SGX instructions such as Intel® SGX instructions.

In one embodiment of the second aspect, the network interface module includes a core driver arranged in the trusted execution environment, the core driver is arranged to receive and process the data stream. The core driver may also be arranged to transmit data stream, e.g., to the gateway via the communication channel. The core driver may be arranged to establish the communication channel, store session keys, and/or control and coordinate networking, encoding, and cryptographic operations associated with the trusted execution environment.

In one embodiment of the second aspect, the core driver is further arranged to maintain a clock module in the trusted execution environment. The clock module may be part of the network interface module. The clock of the clock module may substantially correspond to a clock of the gateway, e.g., optionally with offset, delay, etc.

In one embodiment of the second aspect, the system also includes means for including a timestamp in each of the data packets prior to transmission of the data stream to the network interface module. The inclusion of the timestamp may be part of the processing step for forming the data stream.

In one embodiment of the second aspect, the core driver is further arranged to compare the timestamp in the received data packet with a clock in the clock module; and to update the clock module based on the comparison (e.g., update if needed).

In one embodiment of the second aspect, the network interface module further includes: a poll driver arranged in the trusted execution environment, and operably connected with the core driver and with the middlebox module. The poll driver is arranged to enable the middlebox module to access data packets in the data stream received at the network interface module.

In one embodiment of the second aspect, the network interface module further includes: a receiver repository arranged in the trusted execution environment and arranged between the core driver and the poll driver, the receiver repository is arranged to hold packet data (e.g., extracted from the received data stream) received at the network interface module, e.g., from the gateway via the communication channel. The network interface module also includes a transmission repository arranged in the trusted execution environment and arranged between the core driver and the poll driver.

The transmission repository is arranged to hold packet data to be transmitted (optionally to be processed) out of the network interface module, e.g., to the gateway via the communication channel. The receiver repository and the transmission repository may be separate or at least partly combined. The receiver repository may have a repository size (number of entries) from 150 to 350, from 200 to 300, about 250, or 256. The transmission repository may have a repository size (number of entries) from 150 to 350, from 200 to 300, about 250, or 256. In other embodiments, the receiver repository may have a different (larger or smaller) repository size (number of entries). In other embodiments, the transmission repository may have a different (larger or smaller) repository size (number of entries). In one embodiment of the second aspect, the receiver repository and the transmission repository each has a respective ring-like architecture. The ring-like architecture may be lock-free.

In one embodiment of the second aspect, the poll driver is arranged to pull packet data into the receiver repository and to push data into the transmission repository.

In one embodiment of the second aspect, the poll driver is arranged to operate in a blocking mode, in which a packet is guaranteed to be read or written, and a non-blocking mode. In the non-blocking mode, a packet may not be read or written for each call to the poll driver

In one embodiment of the second aspect, the system also includes means for synchronizing the receiver repository and the transmission repository. The synchronization may relate to the timing of operation.

In one embodiment of the second aspect, the network interface module further includes: a buffer module arranged outside the trusted execution environment and arranged between the core driver and the gateway. The buffer module is arranged to hold a plurality of records (outside the trusted execution environment). The records may be TLS records. The batch size may be from 5 to 15, around 10, or 10. In other embodiments, the batch size can be different (larger or smaller). The packet size may be 64 bytes, 128 bytes, 256 bytes, 512 bytes, 1024 bytes, or even more. In other embodiments, the packet size can be different (larger or smaller). In the embodiment with the buffer module, the network interface module is only partly arranged in the trusted execution environment.

In one embodiment of the second aspect, the network interface module can provide an input/output performance at least in the order of Gbps.

In accordance with a third aspect of the invention, there is provided a non-transitory computer readable medium storing computer instructions that, when executed by one or more processors, are arranged to cause the one or more processors to perform the method of the first aspect. The one or more processors may be arranged in the same device or may be distributed in multiple devices.

In accordance with a fourth aspect of the invention there is provided an article including the computer readable medium of the third aspect.

In accordance with a fifth aspect of the invention there is provided a computer program product storing instructions and/or data that are executable by one or more processors, the instructions and/or data are arranged to cause the one or more processors to perform the method of the first aspect.

In accordance with a sixth aspect of the invention, there is provided a system for facilitating data communication of a trusted execution environment. The system includes one or more processors arranged to: process a plurality of data packets, each including respective metadata, to form a data stream that includes the plurality of data packets. The data stream is a single continuous data stream in application-layer. The one or more processors are further arranged to facilitate transmission of the data stream to or from a network interface module for the trusted execution environment. The one or more processors may initiate or provide the network interface module (if the data stream is transmitted from the network interface module), or a gateway (e.g., a remote gateway remote from the network interface module) in communication with the network interface module (if the data stream is transmitted to the network interface module).

In one embodiment of the sixth aspect, the data stream is encrypted. The encryption may be performed by the one or more processors.

In one embodiment of the sixth aspect, the metadata of each respective data packet includes one or more or all of: packet size, packet count, and/or timestamp. In one embodiment of the sixth aspect, each of the data packets further includes application payload and one or more packet headers. The application payload may include a L4 payload with application content. The one or more packet headers may include one or more or all of: a L2 header, a L3 header, and a L4 header. For example, the one or more packet headers include information associated with one or more or all of: IP address, port number, and/or TCP/IP flag.

In one embodiment of the sixth aspect, the one or more processors are arranged to encode the plurality of data packets, e.g., as part of the processing of the data packets.

In one embodiment of the sixth aspect, the one or more processors are arranged pack the plurality of data packets back-to-back to form the data stream, e.g., as part of the processing of the data packets. The back-to-back packing may be direct (nothing in between two adjacent packets) or indirect (with other data in between two adjacent packets).

In one embodiment of the sixth aspect, the one or more processors are arranged to provide a gateway arranged to communicate with the network interface module via a communication channel. In one embodiment of the sixth aspect, the one or more processors are arranged to provide the network interface module, the network interface module is arranged to communicate with a gateway via a communication channel. The gateway may be a trusted gateway remote from the network interface module and/or remote from the trusted execution environment. The communication channel may be a secure communication channel, such as a Transport Layer Security (TLS) communication channel.

In one embodiment of the sixth aspect, the one or more processors are arranged to: facilitate transmission of one or more heartbeat packets from the gateway to the network interface module via the communication channel. The initiation of the transmission may be by the network interface module or by the gateway.

In one embodiment of the sixth aspect, the trusted execution environment includes a middlebox module implemented in the trusted execution environment, and the network interface module is arranged to be in data communication with the middlebox module (e.g., so that the data packets in the received data stream can be accessed or otherwise used by the middlebox module). The network interface module may be the only data communication interface of the middlebox module, i.e., all external data packet communication with the middlebox module must be performed through the network interface module. The network interface module may be initialized or arranged at least partly (e.g., partly or completely) in the trusted execution environment. The middlebox module may be initialized or arranged completely in the trusted execution environment. In one example, the trusted execution environment includes or is a Software Guard Extension (SGX) enclave. The middlebox module may be a stateful middlebox module.

The trusted execution environment may include a memory environment and/or a processing environment. In one embodiment of the sixth aspect, the trusted execution environment is initialized or provided using one or more processors, or the one or more processors. In the example in which the trusted execution environment includes or is an SGX enclave, the trusted execution environment is initialized or provided using one or more processors that support SGX instructions such as Intel® SGX instructions (e.g., the one or more processors). Optionally, the module(s) and component(s) in the trusted execution environment, such as the middlebox module and the network interface module, may be initialized or provided at least partly (e.g., partly or completely) using the one or more processors (e.g., the one or more processors), e.g., one or more processors that support SGX instructions such as Intel® SGX instructions.

In one embodiment of the sixth aspect, the network interface module includes a core driver arranged in the trusted execution environment, the core driver is arranged to receive and process the data stream. The core driver may also be arranged to transmit data stream, e.g., to the gateway via the communication channel. The core driver may be arranged to establish the communication channel, store session keys, and/or control and coordinate networking, encoding, and cryptographic operations associated with the trusted execution environment.

In one embodiment of the sixth aspect, the core driver is further arranged to maintain a clock module in the trusted execution environment. The clock module may be part of the network interface module. The clock of the clock module may substantially correspond to a clock of the gateway, e.g., optionally with offset, delay, etc.

In one embodiment of the sixth aspect, the one or more processors are arranged to include a timestamp in each of the data packets prior to transmission of the data stream to the network interface module. The inclusion of the timestamp may be part of the processing step for forming the data stream.

In one embodiment of the sixth aspect, the core driver is arranged to compare the timestamp in the received data packet with a clock in the clock module and update the clock module based on the comparison (e.g., update if needed).

In one embodiment of the sixth aspect, the network interface module further includes: a poll driver arranged in the trusted execution environment, and operably connected with the core driver and with the middlebox module. The poll driver is arranged to enable the middlebox module to access data packets in the data stream received at the network interface module.

In one embodiment of the sixth aspect, the network interface module further includes: a receiver repository arranged in the trusted execution environment and arranged between the core driver and the poll driver, the receiver repository is arranged to hold packet data (e.g., extracted from the received data stream) received at the network interface module, e.g., from the gateway via the communication channel. The network interface module also includes a transmission repository arranged in the trusted execution environment and arranged between the core driver and the poll driver. The transmission repository is arranged to hold packet data to be transmitted (optionally to be processed) out of the network interface module, e.g., to the gateway via the communication channel. The receiver repository and the transmission repository may be separate or at least partly combined. The receiver repository may have a repository size (number of entries) from 150 to 350, from 200 to 300, about 250, or 256. The transmission repository may have a repository size (number of entries) from 150 to 350, from 200 to 300, about 250, or 256. In other embodiments, the receiver repository may have a different (larger or smaller) repository size (number of entries). In other embodiments, the transmission repository may have a different (larger or smaller) repository size (number of entries). In one embodiment of the sixth aspect, the receiver repository and the transmission repository each has a respective ring-like architecture. The ring-like architecture may be lock-free.

In one embodiment of the sixth aspect, the poll driver is arranged to pull packet data into the receiver repository and to push data into the transmission repository.

In one embodiment of the sixth aspect, the poll driver is arranged to operate in a blocking mode, in which a packet is guaranteed to be read or written, and a non-blocking mode. In the non-blocking mode, a packet may not be read or written for each call to the poll driver.

In one embodiment of the sixth aspect, the one or more processors are further arranged to synchronize the receiver repository and the transmission repository. The synchronization may relate to the timing of operation.

In one embodiment of the sixth aspect, the network interface module further includes: a buffer module arranged outside the trusted execution environment and arranged between the core driver and the gateway. The buffer module is arranged to hold a plurality of records (outside the trusted execution environment). The records may be TLS records. The batch size may be from 5 to 15, around 10, or 10. In other embodiments, the batch size can be different (larger or smaller). The packet size may be 64 bytes, 128 bytes, 256 bytes, 512 bytes, 1024 bytes, or even more. In other embodiments, the packet size can be different (larger or smaller). In the embodiment with the buffer module, the network interface module is only partly arranged in the trusted execution environment.

In one embodiment of the sixth aspect, the network interface module can provide an input/output performance at least in the order of Gbps.

In accordance with a seventh aspect of the invention, there is provided a network interface module for facilitating data communication of a trusted execution environment. The network interface module is arranged to communicate with a gateway via a communication channel. The network interface module is the network interface module in the system of the sixth aspect (i.e., it may include one or more features of the network interface module in the system of the sixth aspect). The gateway may be a trusted gateway remote from the network interface module and/or remote from the trusted execution environment. The communication channel may be a secure communication channel, such as a Transport Layer Security (TLS) communication channel.

In one embodiment of the seventh aspect, the trusted execution environment includes a middlebox module implemented in the trusted execution environment, and the network interface module is arranged to be in data communication with the middlebox module (e.g., so that the data packets in the received data stream can be accessed or otherwise used by the middlebox module). The network interface module may be the only data communication interface of the middlebox module, i.e., all external data packet communication with the middlebox module must be performed through the network interface module. The network interface module may be initialized or arranged at least partly (e.g., partly or completely) in the trusted execution environment. The middlebox module may be initialized or arranged completely in the trusted execution environment. In one example, the trusted execution environment includes or is a Software Guard Extension (SGX) enclave. The middlebox module may be a stateful middlebox module.

In one embodiment of the seventh aspect, the trusted execution environment is initialized or provided using one or more processors. In the example in which the trusted execution environment includes or is an SGX enclave, the trusted execution environment is initialized or provided using one or more processors that support SGX instructions such as Intel® SGX instructions. Optionally, the module(s) and component(s) in the trusted execution environment, such as the middlebox module and the network interface module, may be initialized or provided at least partly (e.g., partly or completely) using the one or more processors, e.g., one or more processors that support SGX instructions such as Intel® SGX instructions.

In accordance with an eight aspect of the invention, there is provided a computing device or apparatus including the network interface module of the seventh aspect.

### BRIEF DESCRIPTION OF THE DRAWINGS

Embodiments of the invention will now be described, by way of example, with reference to the accompanying drawings in which:

FIG. 1 is a functional block diagram of a computing environment in one embodiment of the invention;

FIG. 2 is a flowchart of a method for facilitating data communication of a trusted execution environment in one embodiment of the invention;

FIG. 3 is a functional block diagram of a computing environment in one embodiment of the invention;

FIG. 4 is a flowchart of facilitating stateful processing of a middlebox module implemented in a trusted execution environment in one embodiment of the invention;

FIG. 5 is a schematic diagram of a computing environment in one embodiment of the invention;

FIG. 6 is a schematic diagram of a system for operating a middlebox in a trusted execution environment (enclave) in one embodiment of the invention;

FIG. 7 is a schematic diagram illustrating different ways of data communication in one embodiment of the invention;

FIG. 8 is a schematic diagram of the network interface module and associated components in the system of FIG. 6;

FIG. 9 is a table illustrating an algorithm arranged to be operated by the network interface module of FIG. 8;

FIG. 10 is a graph showing the performance (throughput (Gbps) vs packet size (byte)) of the network interface module of FIG. 6 using three different synchronization mechanisms;

FIG. 11 is a schematic diagram of a network stack enabled by the network interface module of FIG. 6 in one embodiment of the invention;

FIG. 12 is a schematic diagram of modules with data structures used in a method for facilitating stateful processing of a middlebox module implemented in a trusted execution environment in one embodiment of the invention;

FIG. 13 is a table illustrating an algorithm of a method for facilitating stateful processing of a middlebox module implemented in a trusted execution environment in one embodiment of the invention;

FIG. 14 is a graph showing the performance (speed up vs cache miss rate (%)) when a dual lookup method is employed in the modules in FIG. 12;

FIG. 15 is a showing the performance (miss rate vs packet ID (×1M)) when a dual lookup method is employed in the modules in FIG. 12;

FIG. 16 is a graph showing the performance (throughput (Gbps) vs packet size (byte)) of the network interface module of FIG. 6 using different batch sizes;

FIG. 17 is a graph showing the performance (throughput (Gbps) vs ring size of network interface module “etap”) of the network interface module of FIG. 6;

FIG. 18 is a graph showing the performance (CPU usage (%) vs throughput (Gbps)) of the network interface module of FIG. 6;

FIG. 19 is a graph showing the performance (throughput (Mbps or Gbps) vs packet ID (×1M)) of the network interface module of FIG. 6;

FIG. 20A is a graph showing the performance (packet delay (μs) vs flow #(100k)) of the system of FIG. 6 implemented in PRADS with different variants (Native, Strawman, and LightBox);

FIG. 20B is a graph showing the performance (packet delay (μs) vs flow #(100k)) of the system of FIG. 6 implemented in PRADS with different variants (Native, Strawman, and LightBox);

FIG. 20C is a graph showing the performance (packet delay (μs) vs flow #(100k)) of the system of FIG. 6 implemented in PRADS with different variants (Native, Strawman, and LightBox);

FIG. 21A is a graph showing the performance (packet delay (μs) vs flow #(100k)) of the system of FIG. 6 implemented in lwIDS with different variants (Native, Strawman, and LightBox);

FIG. 21B is a graph showing the performance (packet delay (μs) vs flow #(100k)) of the system of FIG. 6 implemented in lwIDS with different variants (Native, Strawman, and LightBox);

FIG. 21C is a graph showing the performance (packet delay (μs) vs flow #(100k)) of the system of FIG. 6 implemented in lwIDS with different variants (Native, Strawman, and LightBox);

FIG. 22 is a graph showing the performance (packet delay (μs) vs replay timeline (per 1M packets) and flow #(k) vs replay timeline (per 1M packets)) of the system of FIG. 6 implemented in PRADS with different variants (Native, Strawman, and LightBox);

FIG. 23 is a graph showing the performance (packet delay (μs) vs replay timeline (per 1M packets) and flow #(k) vs replay timeline (per 1M packets)) of the system of FIG. 6 implemented in lwIDS with different variants (Native, Strawman, and LightBox);

FIG. 24A is a graph showing the performance (packet delay (μs) vs flow #(100k)) of the system of FIG. 6 implemented in mIDS with different variants (Native, Strawman, and LightBox);

FIG. 24B is a graph showing the performance (packet delay (μs) vs flow #(100k)) of the system of FIG. 6 implemented in mIDS with different variants (Native, Strawman, and LightBox);

FIG. 24C is a graph showing the performance (packet delay (μs) vs flow #(100k)) of the system of FIG. 6 implemented in mIDS with different variants (Native, Strawman, and LightBox);

FIG. 25 is a graph showing the performance (packet delay (μs) vs replay timeline (per 1M packets) and flow #(k) vs replay timeline (per 1M packets)) of the system of FIG. 6 implemented in mIDS with different variants (Native, Strawman, and LightBox);

FIG. 26 is a tables showing overall throughput under CAIDA trace for system of FIG. 6 implemented in PRADS, lwIDS, and mIDS with different variants (Native, Strawman, and LightBox); and

FIG. 27 is a block diagram of an information handling system arranged to implement the system and/or method in some embodiments of the invention.

### DETAILED DESCRIPTION

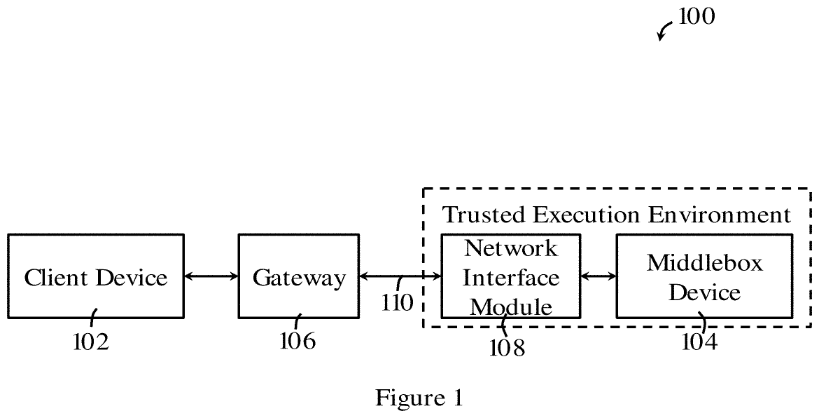

FIG. 1 shows a computing environment 100 in one embodiment of the invention. The computing environment 100 includes a client device 102 and a middlebox device 104 implemented or arranged in a trusted execution environment. The client device 102 is arranged to communicate with the middlebox device 104 via a gateway 106 and a network interface module 108. The network interface module 108 is arranged inside the trusted execution environment. The network interface module 108 may provide an input/output performance at least in the order of Gbps. In one example, the client device 102 and the gateway 106 belong to an enterprise, and the middlebox device 104 and the network interface module 108 belongs to a 3rd party service provider. The client device 102 and the gateway 106 may be arranged on the same computing device or distributed on multiple computing devices. The middlebox device 104 and the network interface module 108 may be arranged on the same computing device or distributed on multiple computing devices. The gateway 106 (hence the client device 102) is remote from the middlebox device 104 and the network interface module 108. The gateway 106 may be a trusted gateway (e.g., designated) that is remote from the network interface module 108 and/or remote from the trusted execution environment. The communication channel 110 between the gateway 106 and the network interface module 108 may be a secure communication channel, such as a Transport Layer Security (TLS) communication channel.

In FIG. 1, the trusted execution environment may be initialized or provided using one or more processors on one or more computing devices. The trusted execution environment may include a memory environment and/or a processing environment. The trusted execution environment may be an SGX enclave in which the trusted execution environment is initialized or provided using one or more processors that support SGX instructions such as Intel® SGX instructions. The module(s), device(s), and component(s) in the trusted execution environment, such as the middlebox module 104 and the network interface module 108, may be initialized or provided at least partly using the one or more processors, e.g., those that support SGX instructions such as Intel® SGX instructions. A person skilled in the art would appreciate that the trusted execution environment, the network interface module 108, the middlebox device 104, the gateway 106, and the client device 102 may each be implemented using hardware, software, or any of their combination.

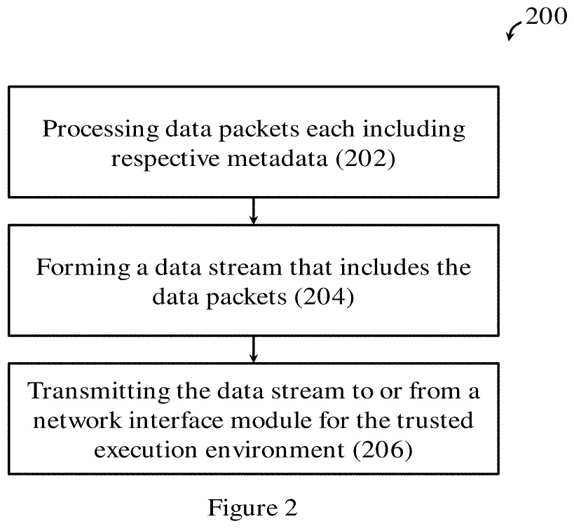

FIG. 2 illustrates a method 200 for facilitating data communication of a trusted execution environment in one embodiment of the invention. The method 200 can be implemented in the environment 100 of FIG. 1. The method 200 generally includes, in step 202, processing data packets each including respective metadata. Then, in step 204, a data stream that includes the data packets is formed. The data stream is a single continuous data stream in application-layer. Specifically, the data stream is arranged such that a boundary between adjacent data packets is not clearly or easily identifiable. Subsequently, in step 206, the data stream is transmitted to or from a network interface module for the trusted execution environment.

One embodiment of the method 200 is now described with reference to the environment 100. In step 202, the data packets are processed by the gateway 106. Each of the data packets includes application payload (e.g., a L4 payload with application content), packet headers (e.g., a L2 header, a L3 header, and a L4 header), and metadata (e.g., packet size, packet count, and timestamp). The packet headers may include information associated with one or more or all of: IP address, port number, and/or TCP/IP flag. The gateway 106 may encode the data packets and pack the data packets back-to-back for forming the data stream. The back-to-back packing may be direct (nothing in between adjacent packets) or indirect (with other data in between adjacent packets). The gateway 106 may further encrypt the data packets. In step 204, the encrypted data stream is formed at the gateway 106. Then, in step 206, the encrypted data stream formed is transmitted from the gateway 106 to the network interface module 108 via the communication channel no. In one embodiment, the gateway 106 may communicate, apart from the data stream, heartbeat packet(s) to the network interface module 108 via the communication channel no, to maintain a minimum communication rate in the channel 110.

Another embodiment of the method 200 is now described with reference to the environment 100. In step 202, the data packets are processed by the network interface module 108. Each of the data packets includes application payload (e.g., a L4 payload with application content), packet headers (e.g., a L2 header, a L3 header, and a L4 header), and metadata (e.g., packet size, packet count, and/or timestamp). In one example, the packet headers include information associated with one or more or all of: IP address, port number, and/or TCP/IP flag. The network interface module 108 may encode the data packets and pack the data packets back-to-back for forming the data stream. The back-to-back packing may be direct (nothing in between two adjacent packets) or indirect (with other data in between two adjacent packets). The network interface module 108 may further encrypt the data packets. In step 204, the encrypted data stream is formed at the network interface module 108. Then, in step 206, the encrypted data stream formed is transmitted from the network interface module 108 to the gateway 106 via the communication channel 110. In one embodiment, the network interface module 108 may communicate, apart from the data stream, heartbeat packet(s) to the gateway via the communication channel 110, to maintain a minimum communication rate in the channel 110.

A person skilled in the art would appreciate that the method 200 can, in some other embodiments with reference to the environment 100, be implemented distributively across the gateway 106 and the network interface module 108. For example, the processing of the data packets can be performed partly by the network interface module 108 and partly by the gateway 106. The method 200 can also be implemented on an environment different from environment 100. Also, it should be noted that the data packets may contain more information or less information. For example, the data packets can include additional information apart from application payload, packet headers, and metadata. Or the data packets can omit one or more of application payload, packet headers, and metadata. In other embodiments, the specific types of application payload, packet headers, and metadata can be different than those described.

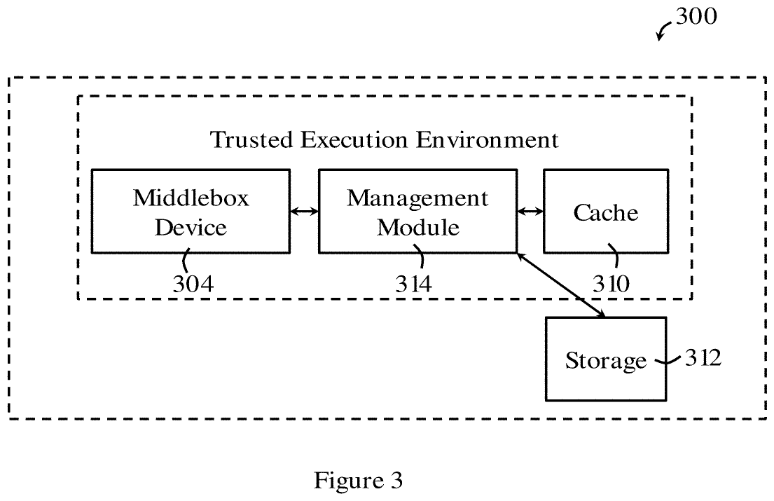

FIG. 3 shows a computing environment 300 in one embodiment of the invention. The computing environment 300 includes a middlebox device 304 and a management module 314 for managing data access and retrieval of the middlebox device 304 arranged in a trusted execution environment. The management module 314 is arranged to access a cache 310 in the trusted execution environment and a storage 312 outside the trusted execution environment (e.g., an untrusted execution environment).

In embodiments in which the trusted execution environment has limited space or resource, the cache 310 may have a smaller capacity than the storage 312. The management module 314 and the middlebox device 304 may be arranged on the same computing device or distributed on multiple computing devices. The storage 312 and the cache 310 may be arranged on the same computing device or distributed on multiple computing devices.

In FIG. 3, the trusted execution environment may be initialized or provided using one or more processors on one or more computing devices. The trusted execution environment may include a memory environment and/or a processing environment. The trusted execution environment may be an SGX enclave in which the trusted execution environment is initialized or provided using one or more processors that support SGX instructions such as Intel® SGX instructions. The module(s), device(s), and component(s) in the trusted execution environment, such as the middlebox device 304 and the management module 314, may be initialized or provided at least partly using the one or more processors, e.g., those that support SGX instructions such as Intel® SGX instructions. A person skilled in the art would appreciate that the trusted execution environment, the management module 314, the middlebox device 304, the cache 310, and the storage 312 may each be implemented using hardware, software, or any of their combination.

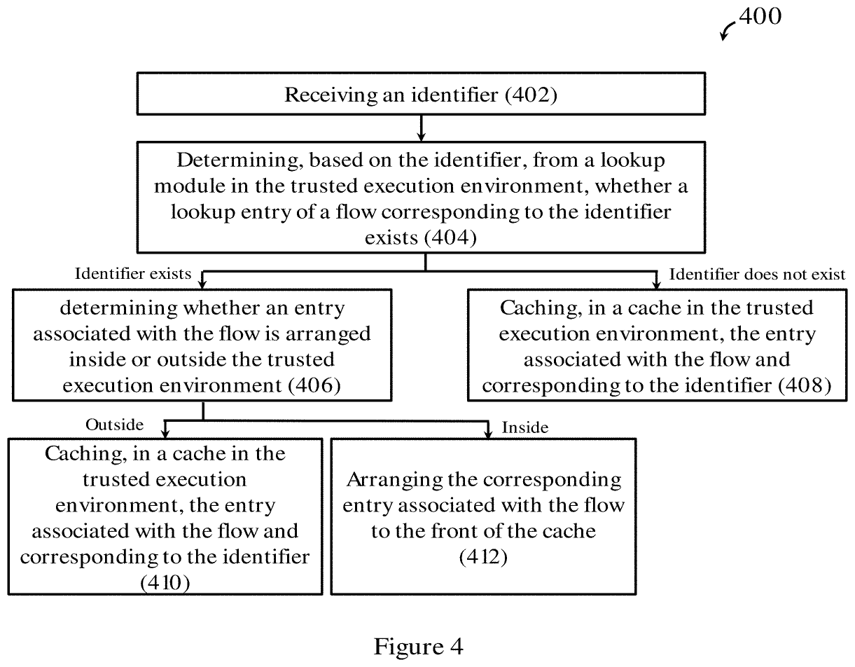

FIG. 4 illustrates a method 400 for facilitating stateful processing of a middlebox module implemented in a trusted execution environment in one embodiment of the invention. The method 400 can be implemented in the environment 300 of FIG. 3. The method 400 generally includes, in step 402, receiving an identifier. The receiving of the identifier may include extracting the identifier from a data packet. Then, in step 404, the method 400 determines whether a lookup entry of a flow corresponding to the received identifier (e.g., a flow associate with the data packet from which the identifier is extracted or otherwise determined) exists. This determination can be based on searching records in a lookup module in the trusted execution environment. The lookup module includes multiple lookup entries each including a respective identifier. In one embodiment, each lookup entry includes a respective identifier and an associated link to either an entry in a cache module inside the trusted execution environment or an entry in a store module outside the trusted execution environment. If in step 404 it is determined that the identifier does not exist, e.g., based on the records of the lookup module, the method 400 proceeds to step 408, in which an entry corresponding to the identifier and associated with the flow of the data packet from which the identifier is extracted or otherwise determined is cached in a cache in the trusted execution environment. Afterwards, the flow state associated with the flow may be provided to or accessed by the middlebox module for processing. Alternatively, if in step 404 it is determined that the identifier exists, e.g., based on the records of the lookup module, the method 400 proceeds to step 406, in which the method 400 determines whether an entry associated with the flow is arranged inside or outside the trusted execution environment. This determination may be based on the information in the lookup entry with the corresponding identifier. If in step 406 it is determined that the entry associated with the flow is stored outside the trusted execution environment, the method 400 proceeds to step 410, in which an entry corresponding to the identifier and associated with the flow of the data packet from which the identifier is extracted or otherwise determined is cached in a cache in the trusted execution environment. Step 410 involves moving the entry from outside the trusted execution environment to inside the trusted execution environment. Afterwards, the flow state associated with the flow may be provided to or accessed by the middlebox module for processing. Alternatively, if in step 406 it is determined that the entry associated with the flow is already cached inside the trusted execution environment, the method 400 proceeds to step 412, in which the corresponding entry associated with the flow is moved the front of the cache. This may include updating a pointer to the entry associated with the flow. Afterwards, the flow state associated with the flow may be provided to or accessed by the middlebox module for processing.

In one example, the method 400 is implemented in the environment 300 of FIG. 3. In step 402, the identifier is extracted or determined by the management module 314, or otherwise received at the management module 314. The identifier may be provided by the middlebox device 304, or any other device. In step 404, the determination can be made by the management module 314, based on a lookup module or table that is, e.g., implemented as part of the management module 314. In step 406, the determination can also be made by the management module 314. In steps 408, 410, 412, the entry corresponding to the identifier and associated with the flow of the data packet from which the identifier is extracted or otherwise determined is cached in the cache 310.

A person skilled in the art would appreciate that the environment 300 in FIG. 3 can be combined with the environment 100 in FIG. 1 such that the middlebox device 104, 304 is the same middlebox device. Also, methods 200 and 400 can be combined and implemented in the same environment.

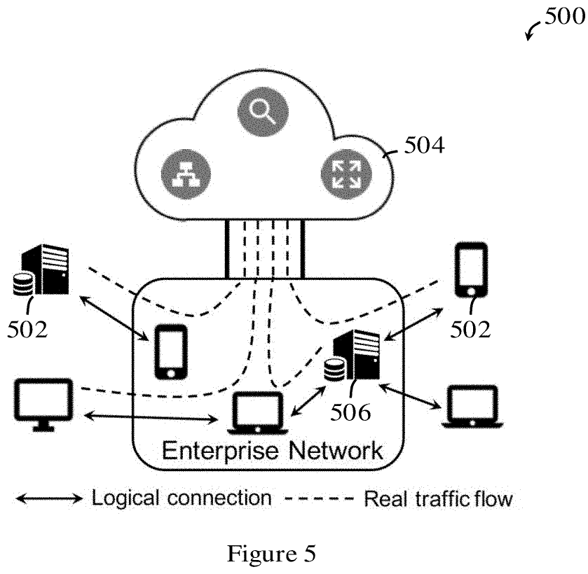

FIG. 5 is a schematic diagram of a computing environment 500 in one embodiment of the invention. The environment 500 includes multiple computing devices 506 (e.g., in the form of desktop computer, phone, server) arranged in an enterprise network, multiple computing devices 502 (e.g., in the form of desktop computer, phone, server) arranged outside the enterprise network and communicatively connected with computing devices 306 in the enterprise network, as well as a middlebox module 504 arranged in a cloud computing network. The computing devices 506 may act as gateways, such as that described with reference to FIGS. 1 and 2. The cloud computing network may further include a network interface module (not shown), such as that described with reference to FIGS. 1 and 2. The middlebox module 504 may be the middlebox device 100, 300 described with reference to FIGS. 1 and 3. The cloud computing network may host the trusted execution environment described with reference to FIGS. 1 and 3. The environment 500 can implement the methods 200, 400 described with reference to FIGS. 2 and 4.

### Specific Implementation—“Lightbox”

The following provides a specific embodiment of a system for operating a middlebox in a trusted execution environment. The system is referred to as “LightBox”, which is a SGX-enabled secure middlebox system that can drive off-site middleboxes at near-native speed with stateful processing and full-stack protection.

### 1. Overview

### 1.1 Service Model

In an exemplary practical service model, an enterprise (e.g., enterprise network with devices 506 in FIG. 5) may direct or redirect its data traffic to the off-site middlebox (e.g., middlebox 504 in FIG. 5) hosted by a service provider for processing. In this example it is assumed that the middlebox code is not necessarily private and may be known to the service provider. This matches practical use cases where the source code is free to use, but only bespoke rule sets are proprietary. Also, in this example, only a single middlebox is considered. These simplifications facilitate and simplify presentation of the core designs of LightBox. It should be appreciated, however, that LightBox can be readily adapted to support service function chaining and disjoint service providers, which mostly involves only changes to the service launching phase.

In terms of traffic forwarding, for ease of exposition, in this example, the bounce model with one gateway is considered. In other words, in this example, both inbound and outbound traffic is redirected from an enterprise gateway to the remote middlebox for processing and then bounced back. In other embodiment, another direct model, where traffic is routed from the source network to the remote middlebox and then directly to the next trusted hop, i.e., the gateway in the destination network, can be implemented, e.g., by installing a etap-cli (see Section 1.3 below) on each gateway.

The communication endpoints (e.g., a client in the enterprise network and an external server) may transmit data via a secure connection or secure communication channel. To enable such already encrypted traffic to be processed by the middlebox, the gateway needs to intercept the secure connection and decrypt the traffic before redirection. In this example, the gateway is arranged to receive the session keys from the endpoints to perform the interception, unbeknownst to the middlebox.

A dedicated high-speed connection will be typically established for traffic redirection. Existing services, for example AWS Direct Connect, Azure ExpressRoute, and Google Dedicated Interconnect, can provide such high-speed connection. The offsite middlebox, while being secured, should also be able to process packet at line rate to benefit from such dedicated links.

### 1.2 SGX Background

SGX introduces a trusted execution environment called enclave to shield code and data with on-chip security engines. It stands out for the capability to run generic code at processor speed, with practically strong protection. Despite the benefits, it has several limitations. First, common system services cannot be directly used inside a trusted execution environment (e.g., enclave). Access to them requires expensive context switching to exit the enclave, typically via a secure API called OCALL. Second, memory access in the enclave incurs performance overhead. The protected memory region used by the enclave is called Enclave Page Cache (EPC). It has a conservative limit of 128 MB in current product lines. Excessive memory usage in the enclave will trigger EPC paging, which can induce prohibitive performance penalties. Besides, the cost of cache miss while accessing EPC is higher than normal, due to the cryptographic operations involved during data transferring between CPU cache and EPC. While such overhead may be negligible to certain applications, it becomes crucial to middleboxes with stringent performance requirements.

### 1.3 LightBox Overview

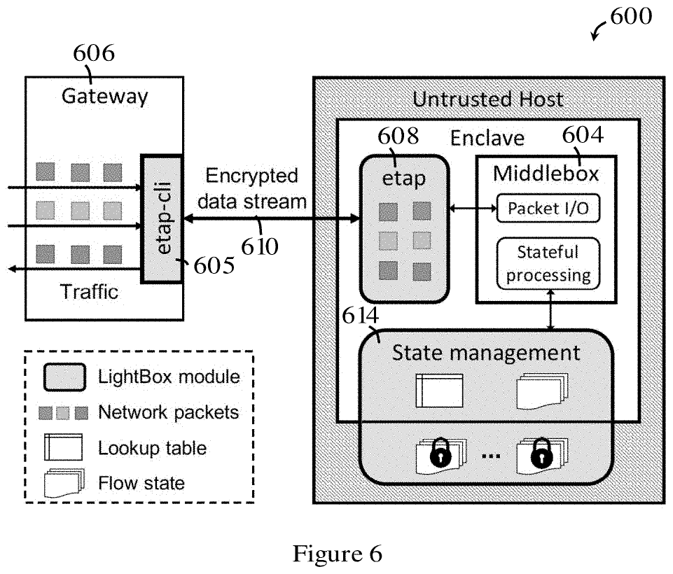

In this embodiment, LightBox leverages an SGX enclave to shield the off-site middlebox. As shown in FIG. 6, a LightBox system 600 comprises two modules to facilitate operation of the middlebox 604: a virtual network interface (or network interface module) “etap” 608 arranged in the enclave and a state management module 614 arranged partly in the enclave. The virtual network interface 608 is functionally similar or equivalent to a physical network interface card (NIC). The virtual network interface 608 enables packets I/O at line rate within the enclave. The state management module 614 provides automatic and efficient memory management of the large amount of flow states tracked by the middlebox 604.

In this embodiment, the etap device 608 is peered with one etap-cli module 605 installed at a gateway 606. A persistent secure communication channel 610 is arranged between the two to tunnel the raw traffic, which is transparently encoded/decoded and encrypted/decrypted by etap 608. In this embodiment, the middlebox 604 and upper networking layers (not shown) can directly access raw packets via etap 608 without leaving the enclave.

The state management module 614 maintains a small flow cache in the enclave, a large encrypted flow store outside the enclave (in the untrusted memory), and an efficient lookup data structure in the enclave. The middlebox 604 can look up or remove state entries by providing flow identifiers. In case a state is not present in the cache but in the store, the state management module 614 will automatically swap it with a cached entry.

To ensure security, an enterprise or user who uses the system 600 needs to attest the integrity of the remotely deployed LightBox instance before launching the service. This is realized by the standard SGX attestation utility. In one example, the enterprise administrator can request a security measurement of the enclave signed by the CPU, and interact with Intel® IAS API for verification. During attestation, a secure channel is established to pass configurations, e.g., middlebox processing rules, etap ring size and flow cache size, to the LightBox instance. For a service scenario in which only two parties (the enterprise and the server provider) are involved, a basic attestation protocol between the two and Intel® IAS is sufficient.

### 1.4 Adversary Model

In line with SGX's security guarantee, a powerful adversary is considered. In this example, it is assumed that the adversary can gain full control over all user programs, OS and hypervisor, as well as all hardware components in the machine (e.g., the computing device with the middlebox 604), with the exception of processor package and memory bus. The adversary can obtain a complete memory trace for any process, except those running in the enclave. The adversary can also observe network communications, modify and drop packets at will. In particular, the adversary can log all network traffic and conduct sophisticated inference to mine or otherwise obtain useful information. One aim of the LightBox embodiment is to thwart practical traffic analysis attacks targeting the original packets that are intended for processing at the off-site middleboxes.

Like many SGX applications, side-channel attacks are considered to be out of scope as they can be orthogonally handled by corresponding countermeasures. That said, the security benefits and limitations of SGX are recognized. In this embodiment, denial-of-service attacks are not considered. The middlebox code is assumed to be correct. Also, the enterprise gateway is assumed to be always trusted and it does not have to be SGX-enabled.

### 2. The Etap Device

The ultimate goal of etap device 608 in FIG. 6 is to enable in-enclave access to the packets intended for middlebox processing (by middlebox 604), as if they were locally accessed from the trusted enterprise networks. Towards this goal, the following design requirements are set:
Full-stack protection: when the packets are transmitted in the untrusted networks, and when they traverse through the untrusted platform of the service provider, none of their metadata is directly leaked.
Line-rate packet I/O: etap 608 should deliver packets at a rate that can catch up with a physical network interface card, without capping the middlebox 604 performance. A pragmatic performance target is 10 Gbps.
High usability: to facilitate use of etap 608, there is a need to impose as few changes as possible to the secured middlebox 604. This implies that if certain network frameworks are used by the middlebox 604, they should be seamlessly usable inside the enclave too.

### 2.1 Overview

In this embodiment, to achieve full-stack protection, the packets communicated between the gateway 606 and the enclave are securely tunneled or otherwise communicated: the original packets are encapsulated and encrypted as the payloads of new packets, which contain non-sensitive header information (i.e., the IP addresses of the gateway and the middlebox server).

Encapsulating and encrypting packets individually, as used in L2 tunneling solution, is simple but is not sufficiently secure in some applications, as it does not protect information pertaining to individual packets, including size, timestamp, and as a result, packet count. On the other hand, padding each packet to the maximum size may hide exact packet size, but this incurs unnecessary bandwidth inflation, and still cannot hide the count and timestamps.

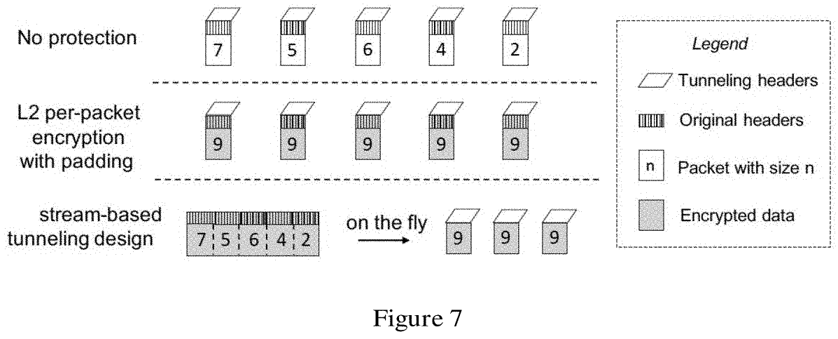

To address this issue, the present embodiment considers encoding the packets as a single continuous stream, which is treated as application payloads and transmitted via the secure communication channel 610 (e.g., TLS communication channel). Such streaming design obfuscates packet boundaries, thus facilitating hiding of metadata that needs to be protected, as illustrated in FIG. 7 (see stream-based tunneling design). Note that FIG. 7 also shows a no protection scheme, and a L2-per-packet encryption with padding scheme, which is inferior to the stream-based tunneling design in the implementation of the present embodiment.

From a system perspective, the key to this approach is the VIF tun/tap (see https://www.kernel.org/doc/Documentation/networking/tuntap.txt) that can be used as an ordinary network interface card to access the tunneled packets, as widely adopted by popular products like OpenVPN. While there are many user space TLS suites and some of them even have handy SGX ports, the tun/tap device itself is canonically driven by the untrusted OS kernel. That is, even if the secure channel can be terminated inside the enclave, the packets are still exposed when accessed via the untrusted tun/tap interface.

To address this issue, the etap (the “enclave tap”) device 608 is arranged to manage packets inside the enclave and enables direct access to them without exiting. From the point of view of the middlebox 604, accessing packets in the enclave via etap 608 is equivalent to accessing packets via a real network interface card in the local enterprise networks.

### 2.2 Architecture

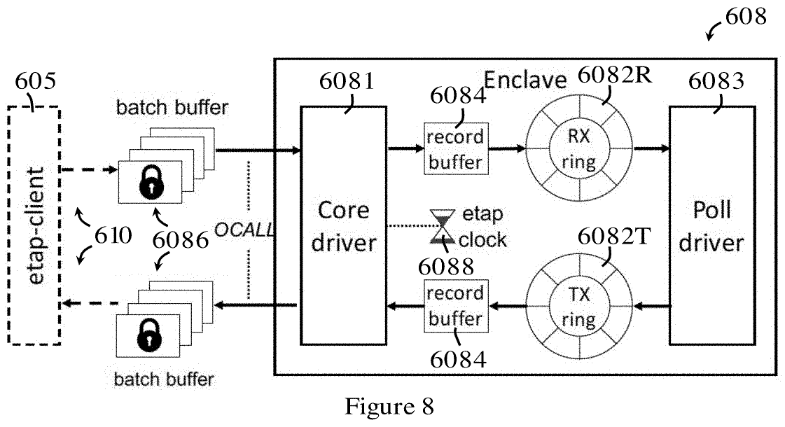

FIG. 8 shows the major components of the virtual network interface (or network interface module) “etap” 608. In this embodiment, each etap 608 is arranged to be peered with an etap-cli module 605 run by the gateway 606 (not shown in FIG. 8). In this embodiment, the “etap” 608 and etap-cli module 605 share the same processing logic. As etap-cli 605 in this embodiment operates as a regular computer program in the trusted gateway 606, its description is omitted. A persistent connection 610 is established between the “etap” 608 and etap-cli module 605 for secure traffic tunneling or communication. The etap peers (e.g., etap-cli module 605) is arranged to maintain a minimal traffic rate by injecting heartbeat packets to the communication channel 610.

The etap 608 includes two repositories, in the form of rings in this embodiment, for queuing packet data: a receiver (RX) repository/ring 6082R and a transmission (TX) repository/ring 6082T. A packet is described by a pkt_info structure, which stores, in order, the packet size, timestamp, and a buffer for raw packet data. Two additional data structures are used in preparing and parsing packets: a record buffer 6084 that holds decrypted data and some auxiliary fields inside the enclave; a batch buffer 6086 that stores multiple records outside the enclave.

The etap device 608 further includes two drivers, a core driver 6081 and a poll driver 6083. The core driver 6081 coordinates networking, encoding and cryptographic operations. The core driver 6081 also maintains a trusted clock 6088 to overcome the lack of high-resolution timing inside the enclave. The poll driver 6083 is used by middleboxes 604 to access packets. The two drivers 6081, 6083 source and sink the two rings 6082T, 6082R accordingly. In other embodiments, multiple RX/TX rings can be arranged for implementing multi-threaded middleboxes.

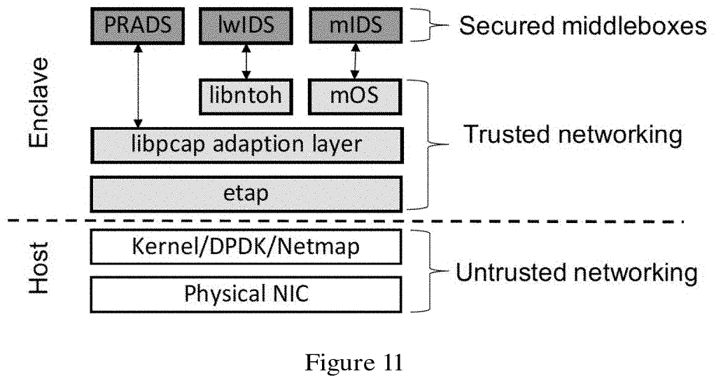

The design of etap 608 is agnostic to how the real networking outside the enclave is performed. For example, it can use standard kernel networking stack (as in this embodiment). For better efficiency, it can also use faster user space networking frameworks based on DPDK or netmap, as shown in FIG. 11.

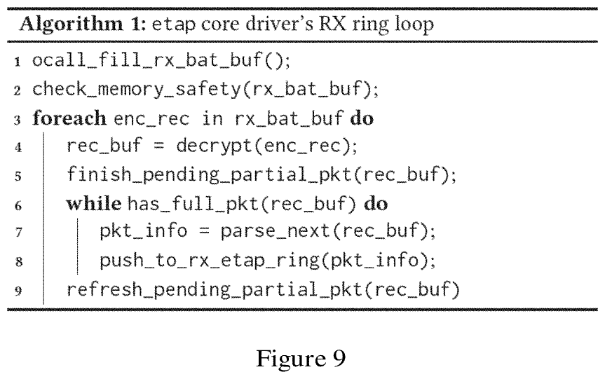

Operation of the core driver 6081 is further described. Upon initialization, the core driver 6081 takes care of necessary handshakes (via OCALL) for establishing the secure communication channel 610 and stores the session keys inside the enclave. The packets intended for processing are pushed into the established secure connection in a back-to-back manner, forming a data stream at the application layer. At the transportation layer, they are effectively organized into contiguous records (e.g., TLS records) of fixed size (e.g., 16 KB for TLS), which then at the network layer are broken down into packets of maximum size. Each original packet is transmitted in the exact format of pkt_info. As a result the receiver can recover, from the continuous stream, the original packet by first extracting its length, the timestamp, and then the raw packet data. The core driver 6081 in this example is run by its own thread. FIG. 9 illustrates the main RX loop algorithm (pseudo code) arranged to be operated by the network interface module of FIG. 8. The main TX loop algorithm is similar to the main RX loop algorithm.

In operation, middleboxes 604 often demand reliable timing for packet timestamping, event scheduling, and performance monitoring. Thus its timer should at least cope with the packet processing rate, i.e., at tens of microseconds. The SGX platform provides trusted relative time source, but its resolution is too low (at seconds) for use in this example. Some other approaches resort to system time provided by OS and on-network interface card PTP clock. Yet, they both access time from untrusted sources, thus subject to adversarial manipulation. Another system fetches time from a remote trusted website, and its resolution (at hundreds of milliseconds) is still unsatisfactory for middlebox systems.

In this embodiment, a reliable clock is provided by taking advantage of etap's 608 design. Specifically, etap-cli module 605 is used as a trusted time source to attach timestamps to the forwarded packets. The core driver 6081 can then maintain a clock 6088 (e.g., with proper delay, offset) by updating it with the timestamp of each received packet from the gateway 605. The resolution of the clock 6088 is determined by the packet rate, which in turn bounds the packet processing rate of the middlebox 604. Therefore, the clock 6088 should be sufficient for most timing tasks found in middlebox 604. Furthermore, the clock 6088 is collated periodically with the round-trip delay estimated by the moderately low-frequency heartbeat packets sent from etap-cli 605, in a way similar to the NTP protocol. Besides accuracy, such heartbeat packets additionally ensure that any adversarial delaying of packets, if it exceeds the collation period, will be detected when the packets are received by etap. The etap clock 6081 fits well for middlebox 604 processing in targeted high-speed networks.

Operation of the poll driver 6083 is further described. The poll driver 6083 provides access to etap 608 for upper layers. It supplies two basic operations, read_pkt to pop packets from RX ring 6082R, and write_pkt to push packets to TX ring 6082T. Unlike the core driver 6081, the poll driver 6083 is run by the middlebox thread. The poll driver 6083 has two operation modes, a blocking mode and a non-blocking mode. In the blocking mode, a packet is guaranteed to be read from or write to etap 608: in case the RX/TX ring 6082R, 6082T is empty/full, the poll driver 6083 will spin until the ring 6082R, 6082T is ready. In the non-blocking mode, the driver 6083 returns (e.g., the packets) immediately if the rings 6082R, 6082T are not ready. In other words, a packet may not be read or written for each call to the poll driver 6083. This will allow the middlebox more CPU time for other tasks, e.g., processing cached events.

### 2.3 Security Analysis

The need to protect application payloads in the traffic is obvious. In this embodiment, one focus is to protect metadata, alone or in combination with application payloads. The following considers a passive adversary only, because the active ones who attempt to modify any data will be detected by the employed authenticated encryption.

Metadata protection is now described. Imagine an adversary located at the ingress point of the service provider's network, or one that has gained full privilege in the middlebox server. The adversary can sniff the entire tunneling traffic trace between the etap peers (e.g., etap and etap-cli). As illustrated in FIG. 7, however, the adversary is not able to infer the packet boundaries from the encrypted stream embodied as the encrypted payloads of observable packets, which have the maximum size most of the time. Therefore, the adversary cannot learn the low-level headers, size and timestamps of the encapsulated individual packets in transmission. This also implies that the adversary is unable to obtain the exact packet count (though this number is always bounded in a given period of time by the maximum and minimum possible packet size). Besides, the timestamp attached to the packets delivered by etap comes from the trusted clock, so it is invisible to the adversary. As a result, a wide range of traffic analyses that directly leverage the metadata will be thwarted, as no such information is available to the adversary.

### 2.4 Performance Boosting

While ensuring strong protection, etap 608 is hardly useful if it cannot deliver packets at a practical rate. Thus, the present embodiment synergizes several techniques to boost its performance.

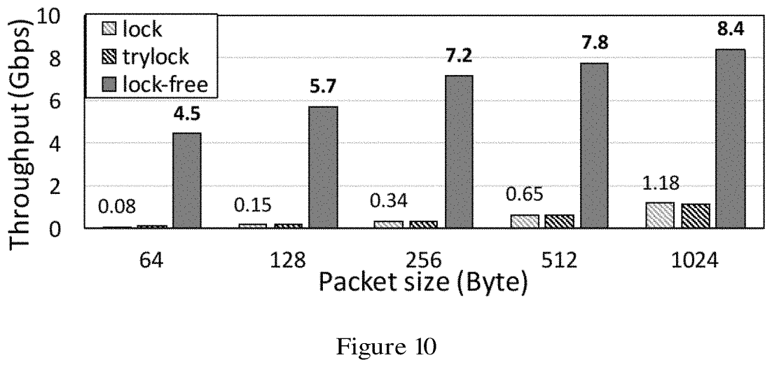

One such technique is a lock-free ring (i.e., ring 6082R, 6082T that is lock-free). The packet rings 6082R, 6082T need to be synchronized between the two drivers 6081, 6083 of etap 608. The performance of three synchronization mechanisms (approaches) is compared: a basic mutex (sgx_thread_mutex_lock), a spinlock without context switching (sgx_thread_mutex_trylock), and a classic single-producer-single-consumer lockless algorithm. The result is shown in FIG. 10. The evaluation shows that the trusted synchronization primitives of SGX are too expensive for the use of etap (see FIG. 10), so in this embodiment further optimizations are made based on the lock-free design.

In one embodiment, a cache-friendly ring access is applied. In the lock-free design, frequent updates on control variables will trigger a high cache miss rate, the penalty of which is amplified in the enclave. In this embodiment, the cache-line protection technique is applied to relieve this issue. It works by adding a set of new control variables local to the threads to reduce the contention on shared variables. Related evaluations have shown that this optimization results in a performance gain up to 31%.

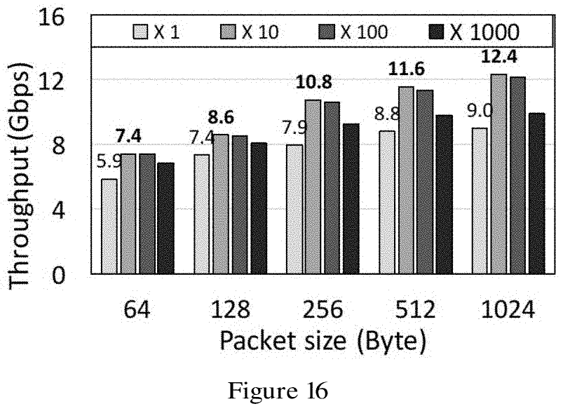

In one embodiment, disciplined record batching is employed. Recall that the core driver uses bat_buf to buffer the records. The buffer size has to be properly set for best performance. If too small, the overhead of OCALL cannot be well amortized. If too large, the core driver 6081 needs longer time to perform I/O: this would waste CPU time not only for the core driver 6081 that waits for I/O outside the enclave, but also for a fast poll driver 6083 that can easily drain or fill the ring 6082R, 6082T. Through extensive experiments, it has been found that a batch size around 10 is optimal to deliver practically the best performance for different packet sizes in settings used in this example, as illustrated in FIG. 16.

### 2.5 Usability

A main thrust of etap 608 is to provide convenient networking functions to in-enclave middlebox 604, preferably without changing their legacy interfaces. On top of etap 608, in some embodiments, existing frameworks can be ported and new frameworks can be built. Three potting examples, which improve the usability of etap 608, are presented below.

First consider the compatibility with libpcap (see The Tcpdump Group. 2018. libpcap. Online at: https://www.tcpdump.org). libpcap is widely used in networking frameworks and middleboxes for packet capturing, so, in one example, an adaption layer that implements libpcap interfaces over etap, including the commonly used packet reading routines (e.g., pcap_loop, pcap_next), and filter routines (e.g., pcap_compile), can be created. This layer allows many legacy systems to transparently access protected raw packets inside the enclave based on the etap 608 embodiment presented.

Next consider TCP reassembly (see Chema García. 2018. libntoh. Online at: https://github.com/sch3m4/libntoh). This common function organizes the payloads of possibly out-of-order packets into streams for subsequent processing. To facilitate middleboxes demanding such functionality, a lightweight reassembly library libntoh is ported on top of etap. It exposes a set of APIs to create stream buffers for new flows, add new TCP segments, and flush the buffers with callback functions.

Then, consider advanced networking stack. In one implementation, an advanced networking stack called mOS, which allows for programming stateful flow monitoring middleboxes, is potted into the enclave on top of etap. As a result, a middlebox built with mOS can automatically enjoy all security and performance benefits of etap, without the need for the middlebox developer to even have any knowledge of SGX. The porting is a non-trivial task as mOS has complicated TCP context and event handling, as well as more sophisticated payload reassembly logic than libntoh. In one example, the porting retains the core processing logic of mOS and only removes the threading features.

Note that the two stateful frameworks above track flow states themselves, so running them inside the enclave efficiently requires delicate state (in particular, flow state) management, as discussed below.

### 3. Flowstate Management

To avoid or remove the expensive application-agnostic EPC paging, in this embodiment, the SGX application is carefully partitioned into two parts: a small part that can fit in the enclave, and a large part that can securely reside in the untrusted main memory. Also in this embodiment, data swapping between the two parts are enabled in an on-demand manner.

To effective implementation, a set of data structures specifically for managing flow states in stateful middleboxes has been provided in this embodiment. The data structures are compact, such that collectively adding a few tens of MBs overhead to track one million flows concurrently. The data structures are also interlinked, such that the data relocation and swapping involves only cheap pointer operations in addition to necessary data marshalling. To overcome the bottleneck of flow lookup, the present embodiment applies the space-efficient cuckoo hashing to create a fast-dual lookup algorithm. Altogether, the state management scheme in this embodiment introduces small and nearly constant computation cost to stateful middlebox processing, even with 100,000s of concurrent flows.

This section focuses on flow-level states, which are the major culprits that overwhelm memory. Other runtime states, such as global counters and pattern matching engines, do not grow with the number of flows, so they are left in the enclave and handled by EPC paging whenever necessary in this example. Experiments have confirmed that the memory explosion caused by flow states is the main source of performance overhead.

### 3.1 Data Structures

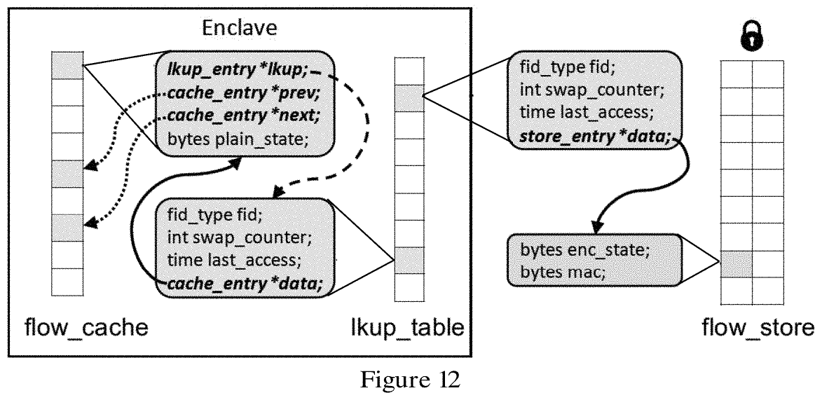

The state management is centered around three modules (with tables) illustrated in FIG. 12:
flow_cache, which maintains the states of a fixed number of active flows in the enclave;
flow_store, which keeps the encrypted states of inactive flows outside the enclave (e.g., in the untrusted memory);
lkup_table, which allows fast lookup of all flow states from within the enclave.

Among them, flow_cache has a fixed capacity, while flow_store and lkup_table have variable capacity. Specifically, flow_store and lkup_table can grow as more flows are tracked. The design principle in this embodiment is to keep the data structures of flow_cache and lkup_table functional and minimal, so that they can scale to millions of concurrent flows.

As shown in FIG. 12, flow_cache holds raw state data. Each entry in flow_cache includes two pointers (dotted arrows) to implement the Least Recently Used (LRU) eviction policy and a link (dashed arrow) to a lkup_entry. Each entry in flow_store holds encrypted state data and authentication media access control address (MAC). It is maintained in untrusted memory so does not consume enclave resources. Each entry in lkup_table stores an identifier (e.g., flow identifier) fid, a pointer (solid arrow) to either cache_entry or store_entry, a swap_count and a last_access. The fid represents the conventional 5-tuple to identify flows. The swap_count serves as a monotonic counter to ensure the freshness of state. In one example, the counter is initialized to a random value and incremented by 1 on each encryption. The last_access assists flow expiration checking. In one example, the last_access is updated with the etap clock on each flow tracking. Note that the design of entry in lkup_table is independent of the underlying lookup structure, which for example can be plain arrays, search trees or hash tables.

The data structures above are succinct, making it efficient to handle high flow concurrency. Assume 8 B (byte) pointer and 13 B fid, then cache_entry uses 24 B per cached flow and lkup_entry uses 33 B per tracked flow. Assume 16K cache entries and full utilization of the underlying lookup structure, then tracking 1M flows requires only 33.8 MB enclave memory besides the state data itself.

### 3.2 Management Procedures

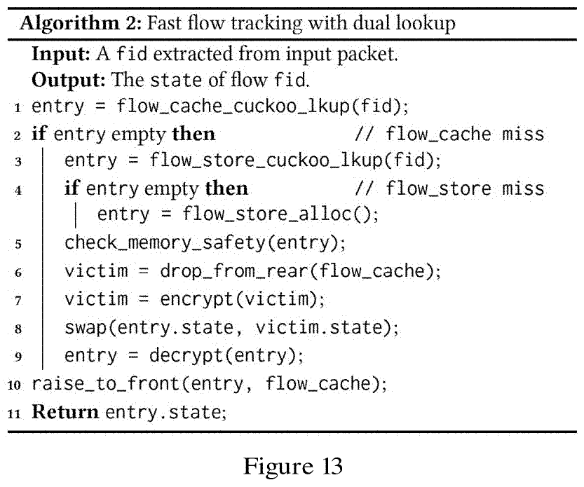

In the context of this section, flow tracking refers to the process of finding the correct flow state on a given fid. Generally, flow tracking takes place in the early stage of the packet processing cycle. The identified state may be accessed anywhere and anytime afterwards. Thus, it should be pinned in the enclave immediately after flow tracking to avoid being accidentally paged out. The full flow tracking procedure is described in algorithm 2 (pseudo code) shown in FIG. 13.

Upon initialization, flow_cache, flow_store, and lkup_table may be pre-allocated with entries. this improves efficiency. During initialization, a random key is generated and stored inside the enclave for the required authenticated encryption.

Details of flow tracking in one example of the invention is now presented. First, given a fid, a search through lkup_table is performed to check if the flow has been tracked in the lkup_table. If, based on the lkup_table, it is found to be in flow_cache, the flow is related to the front of the cache by updating its logical position via the pointers, and the raw state data is returned. If, based on the lkup_table, it is found to be in flow_store, the flow with be swapped with the LRU victim in flow_cache. In case of a new flow (not found based on the lkup_table), an empty store_entry is created for the swapping. In this embodiment the swapping involves a series of strictly defined operations: 1) Checking memory safety of the candidate store_entry; 2) Encrypting the victim cache_entry; 3) Decrypting the store_entry to the just freed flow_cache cell; 4) Restoring the lookup consistency in the lkup_entry; and 5) Moving the encrypted victim cache_entry to store_entry. At the end of flow tracking, the expected flow state will be cached in the enclave and returned to the middlebox.

In one implementation, the tracking of a flow can be explicitly terminated (e.g., upon seeing FIN or RST flag). When this happens, the corresponding lkup_entry is removed and the cache_entry is nullified. This will not affect flow_store, as the flow has already been cached in the enclave.

Optionally, expired flow states in one or more of flow_cache, flow_store, and lkup_table can be periodically purged to avoid performance degradation. The last access time field will be updated at the end of flow tracking for each packet using the etap clock. The checking routine will walk through the lookup_table and remove inactive entries from the tables.

### 3.3 Fast Flow Lookup

The fastest path in the flow tracking process above is indicated by flow_cache hit, where only a few pointers are updated to refresh LRU linkage. In case of flow_cache miss and flow_store hit, two memory copy (for swapping) and cryptographic operations are entailed. Due to the interlinked design, these operations have constant cost independent of the number of tracked flows.

When encountering high flow concurrency, it has been found that the flow lookup sub-procedure becomes the main factor of performance slowdown, as confirmed by one of the tested middleboxes with an inefficient lookup design (PRADS, presented below). Given the constrained enclave resources, two requirements are therefore imposed on the underlying lookup structure: search efficiency and space efficiency.

In one implementation, a dual lookup design with cuckoo hashing is employed. Cuckoo hashing can simultaneously achieve the two properties. It has guaranteed O(1) lookup and superior space efficiency, e.g., 93% load factor with two hash functions and a bucket size of 4. One downside with hashing is their inherent cache-unfriendiness, which incurs a higher cache miss penalty in the enclave. Thus, while adopting cuckoo hashing, a cache-aware design is required.

To this end, in one embodiment, the lkup_table is split into a small table dedicated for flow_cache, and a large table dedicated for flow_store. The large table is searched only after a miss in the small table. The small table contains the same number of entries as flow_cache and has a fixed size that can well fit into a typical L3 cache (8 MB). It is accessed on every packet and thus is likely to reside in L3 cache most of the time. Such a dual lookup design can perform especially well when the flow_cache miss rate is relatively low.

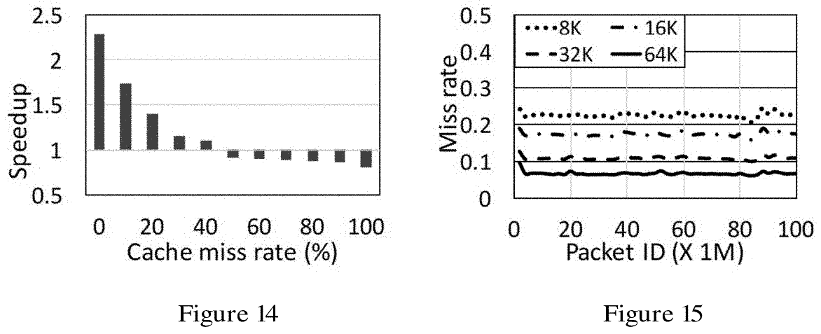

To validate the design, the two lookup approaches were evaluated with 1M flows, 512 B states and flow_cache with 32K entries. As expected, FIG. 14 shows that the lower the miss rate, the larger speedup the dual lookup achieves over the single lookup. Real-world traffic often exhibits temporal locality. The miss rate of flow_cache over a real trace is also estimated. As shown in FIG. 15, the miss rate can be maintained well under 20% with 16K cache entries, confirming the temporal locality in the trace, hence the efficiency of the dual lookup design in practice.

### 3.4 Security of State Management

Through the above implementation, the adversary can only gain little knowledge from the management procedures. In particular, the adversary cannot manipulate the procedures to influence middlebox behavior. Therefore, the above-described management scheme retains the same security level as if it is not applied, i.e., when all states are handled by EPC paging.

First, consider the adversary's view throughout the procedures. Among the three tables, flow_cache and lkup_table are always kept in the enclave, hence invisible to the adversary. flow_store is fully disclosed as it is stored in untrusted memory. The adversary can obtain all entries in flow_store, but never sees the state in clear text. The adversary will notice the creation of new flow state, but cannot link it to a previous one, even if the two have exactly the same content, because of the random initialization of the swap_count. Similarly, the adversary is not able to track traffic patterns (e.g., packets coming in bursts) of a single flow, because the swap_count will increment upon each swapping and produce different ciphertexts for the same flow state. In general, the adversary cannot link any two entries in flow_store. Also, the explicit termination of a flow is unknown to the adversary, as the procedure takes place entirely in the enclave. The adversary will notice state removal events during expiration checking. Yet, this information is useless as the entries are not linkable. Even if the adversary is an active adversary: due to the authenticated encryption, any modification of entries of flow_state is detectable. Malicious deletion of entries of flow_state will be also caught when it is supposed to be swapped into the enclave after a hit in a lkup_table. The adversary cannot inject a fake entry since lkup_table is inaccessible. Furthermore, the replay attack will be thwarted because swap_count keeps the freshness of the state.

### 4 Instantiations of Lightbox

A working prototype of LightBox has been implemented, and three case-study stateful middleboxes have been instantiated, for evaluation

### 4.1 Porting Middleboxes to SGX

A middlebox system should be first ported to the SGX enclave before it can enjoy the security and performance benefits of LightBox, as illustrated in FIG. 6. After that, the middlebox's original insecure I/O module will be seamlessly replaced with etap and the network frameworks stacked thereon; its flow state management procedures, including memory management, flow lookup and termination, will be changed to that of LightBox as well.

There are several ways to port a legacy middlebox. One is to build the middlebox with trusted LibOS, which are pre-ported to SGX and support general system services within the enclave. Another more specialized approach is to identify only the necessary system services and customize a trusted shim layer for optimized performance and TCB size. To prepare for the middlebox case-studies below, the second approach is used. A shim layer that supports the necessary system calls and struct definitions is implemented. Some prior systems allow modular development of middleboxes that are automatically secured by SGX. For middleboxes built this way, their network I/O and flow state management modules can be directly substituted using LightBox, augmenting them with full-stack protection and efficient stateful processing.

### 4.2 Middlebox Case Studies

Three middleboxes instantiated for Light-Box are now described. To simplify discussions, the following assumes that they have already been ported to SGX. Both PRADS and lwIDS use libpere for pattern matching, so it is manually ported as a trusted library to be used within the enclave.

The first one is PRADS. See Edward Fjellskål. 2017. Passive Real-time Asset Detection System. Online at: https://github.com/gamelinux/prads. PRADS can detect network assets (e.g., OSes, devices) in packets against predefined fingerprints, and has been widely used in academic research. It uses libpcap for packet I/O, so its main packet loop can be directly replaced with the compatibility layer built on etap. The flow tracking logic is adapted to LightBox's state management procedures without altering the original functionality. This affects about 200 lines of code (LoC) in the original PRADS project with 10K LoC.

The second one is lwIDS (lightweight intrusion detection system). Based on the tcp reassembly library libntoh (introduced above), a lightweight IDS that can identify malicious patterns over reassembled data is built. In this implementation, whenever the stream buffer is full or the flow is completed, the buffered content will be flushed and inspected against a set of patterns. Note that the packet I/O and main stream reassembly logic of lwIDS is handled by libntoh (3.8K LoC), which have already been ported on top of etap. The effort of instantiating LightBox for lwIDS thus reduces to adjusting the state management module of libntoh, which amounts to a change of around 100 LoC.

The third one is mIDS.

Amore comprehensive middlebox, called mIDS, is designed based on the mOS framework in Muhammad Asim Jamshed, YoungGyoun Moon, Donghwi Kim, Dongsu Han, and KyoungSoo Park. 2014. mOS: A Reusable Networking Stack for Flow Monitoring Middleboxes. In Proc. of USENIX NSD. and the pattern matching engine DFC in Byungkwon Choi, Jongwook Chae, Muhammad Jamshed, Kyoungsoo Park, and Dongsu Han. 2016. DFC: Accelerating string pattern matching for network applications. In Proc. of USENIX NSDI. Similar to lwIDS, mIDS will flush stream buffers for inspection upon overflow and flow completion; but to avoid consistent failure, it will also do the flushing and inspection when receiving out-of-order packets. Again, since mOS (26K LoC) have been ported with etap, the remaining effort of instantiating LightBox for mIDS is to modify the state management logic, resulting in 450 LoC change. Note that such effort is one-time only: hereafter, it is possible to instantiate any middlebox built with mOS without change.

### 5. Evaluation

### 5.1 Methodology and Setup

The evaluation in this disclosure comprises two main parts: in-enclave packet I/O, where etap is evaluated in various aspects to decide the practically optimal configurations; middlebox performance, where the efficiency of LightBox is measured against a native and a strawman approach for the three case-study middleboxes. A real SGX-enabled workstation with Intel® E3-1505 v5 CPU and 16 GB memory in the experiments. Equipped with 1 Gbps network interface card, the workstation is unfortunately incapable of reflecting etap's real performance, so two experiment setups have been prepared and used. In the following, K is used to represent thousand in the units and M is used to represent million in the units.

Setup 1. The first setup is dedicated for evaluation on etap, where etap-cli and etap are run on the same standalone machine and are allowed to communicate with the fast memory channel via kernel networking. Note that etap-cli needs no SGX support and runs as a normal user-land program. To reduce the side effect of running them on the same machine, the kernel networking buffers are tamed such that they are kept small (500 KB) but functional. The intent here is to demonstrate that etap can catch up with the rate of a real 10 Gbps network interface cards in practical settings.

Setup 2. Deployed in a local 1 Gbps LAN, the second setup is for evaluating middlebox performance. This setup uses a separate machine as the gateway to run etap-cli, so it communicates with etap via the real link. The gateway machine also serves as the server to accept connections from clients (on other machines in the LAN). Then use tcpkali, as in Satori. 2017. Fast multi-core TCP and WebSockets load generator. Online at: https://github.com/machinezone/tcpkali, to generate concurrent TCP connections transmitting random payloads from clients to the server; all ACK packets from the server to clients are filtered out. The environment can afford up to 600K concurrent connections. A real trace is obtained from CAIDA for experiments, The trace is collected by monitors deployed at backbone networks. The trace is sanitized and contains only anonymized L3/L4 headers, so they are padded with random payloads to their original lengths specified in the header. The first 100M packets from the trace is used in the experiments.

5.2 in-Enclave Packet I/O Performance

To evaluate etap, a bare middlebox is created, which keeps reading packets from etap without further processing. It is referred to as PktReader. A large memory pool (8 GB) is kept and packets are fed to etap-cli directly from the pool.

One investigation concerns how batching size can affects etap performance. The ring size is set as 1024. As shown in FIG. 16, the optimal size appears between 10 and 100 for all packet sizes. The throughput drops when the batching size becomes either too small or overly large. With a batching size of 10, etap can deliver small 64 B (byte) packet at 7.4 Gbps, and large 1024 B packet at 12.4 Gbps, which is comparable to advanced packet I/O framework on modern 10 Gbps network interface card. Thus, 10 is set as the default batching size and is used in all following experiments.

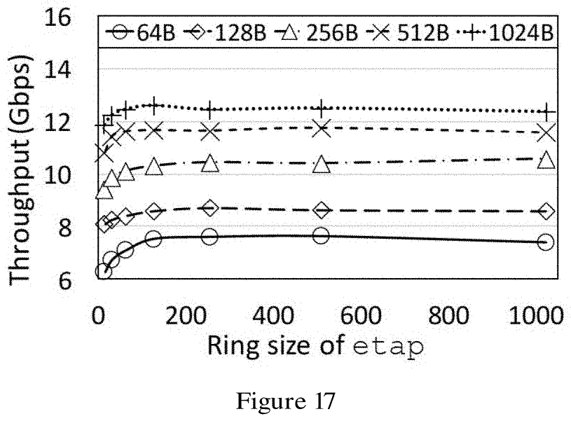

Shrinking etap ring is beneficial in that precious enclave resources can be saved for middlebox functions, and in the case of multi-threaded middleboxes, for efficiently supporting more RX rings. However, smaller ring size generally leads to lower I/O throughput. FIG. 17 shows the results with varying ring sizes. As can be seen, the tipping point occurs around 256, where the throughput for all packet sizes begins to drop sharply as ring size decreases. Beyond that and up to 1024, the performance appears insensitive to ring size. Thus, 256 is used as the default ring size in all subsequent tests.

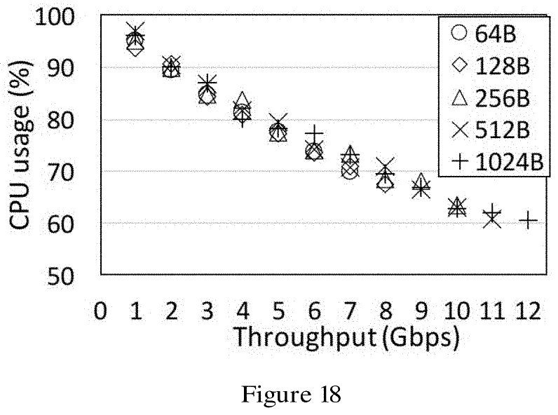

In terms of resource consumption, the rings contribute to the major etap enclave memory consumption. One ring uses as small as 0.38 MB asper the default configuration, and a working etap consumes merely 0.76 MB. The core driver of etap is run by dedicated threads and its CPU consumption is of interest. The driver will spin in the enclave if the rings are not available, since exiting enclave and sleeping outside is too costly. This implies that a slower middlebox thread will force the core driver to waste more CPU cycles in the enclave. To verify such effect, PkgReader is tuned with different levels of complexity, and the core driver's CPU usage is determined under varying middlebox speed. As expected, the results in FIG. 18 show a clear negative correlation between the CPU usage of etap and the performance of middlebox itself. With 70% utilization of a single core the core driver can handle packets at its full speed. Overall, it can be seen that an average commodity processor is more than enough for the target 10 Gpbs in-enclave packet I/O.

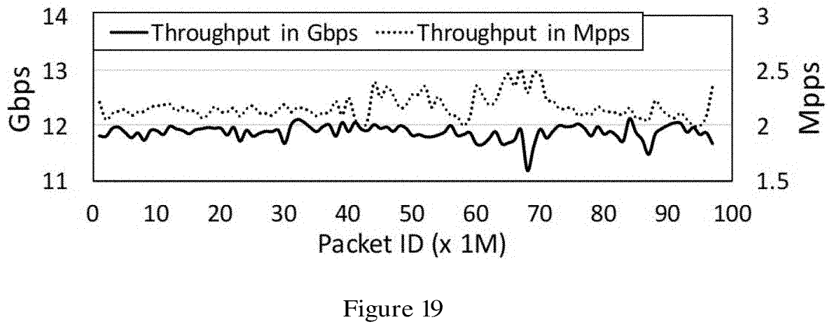

FIG. 19 shows etap's performance on the real CAIDA trace that has a mean packet size of 680 B. The throughput for every 1M packets is estimated while replaying the trace to etap-cli. As shown, although there are small fluctuations overtime due to varying packet size, the throughput remains mostly within 11-12 Gbps and 2-2.5 Mpps. This further demonstrates etap's practical I/O performance.

### 5.3 Middlebox Performance

The performance of the three middleboxes, each with three variants, is studied: the vanilla version (denoted as Native) running as a normal program; naive SGX port (denoted as Strawman) that uses etap and the ported libntoh and mOS for networking, but relies on EPC paging for however much enclave memory is needed; the LightBox instance as described above. It is worth noting that despite the name, the Strawman variants actually benefit a lot from etap's efficiency. The goal here is primarily to investigate the efficiency of the state management design.

Default configurations are used for all three middleboxes unless otherwise specified. For lwIDS 10 pere engines are compiled with random patterns for inspection; for mIDS the DFC engine is built with 3700 patterns extracted from Snort community ruleset. The flow state of PRADS, lwIDS, and mIDS has a size of 512 B (PRADS has 124B flow state, which is too small under the experiment settings. To better approximate realistic scenarios, the flow state of PRADS has been padded to 512 B with random bytes. No such padding is applied to lwIDS and mIDS), 5.5 KB, and 11.4 KB (This size is resulted from the rearrangement of mOS's data structures pertaining to flow state. All data structures are merged into a single one to ease memory management), respectively; the latter two include stream reassembly buffer of size 4 KB and 8 KB. For LightBox variants, the number of entries of flow_cache is fixed to 32K, 8K and 4K for PRADS, lwIDS, and mIDS, respectively.

### 5.3.1 Controlled Live Traffic

To gain a better understanding of how stateful middleboxes behave in the highly constrained enclave space, they have been tested in controlled settings with varying number of concurrent TCP connections between clients and the server. The clients' traffic generation load is controlled such that the aggregated traffic rate at the server side remains roughly the same for different degrees of concurrency. By doing so the comparisons are made fair and meaningful. In addition, data points are started to be collected only when all connections are established and stabilized. The mean packet processing delay is measured in microsecond (μs) every 1M packets, and each reported data point is averaged over 100 runs.

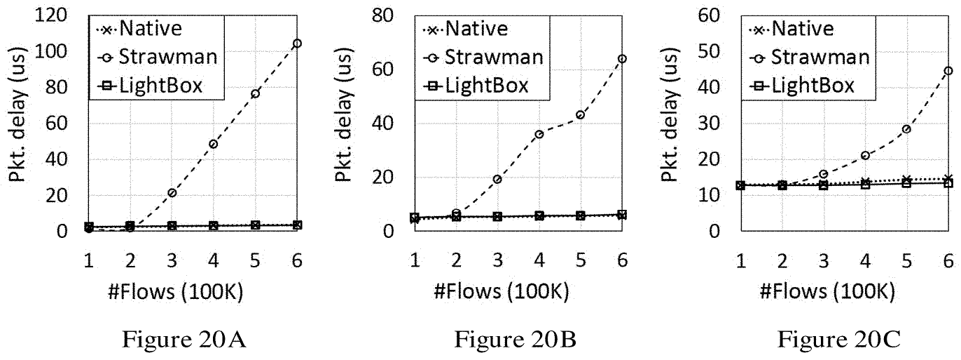

FIG. 20A to 20C. show the results for PRADS. From FIG. 20A to 20C, it can be seen that LightBox adds negligible overhead (<1 μs) to native processing of PRADS regardless of the number of flows. In contrast, Strawman incurs significant and increasing overhead after 200K flows, due to the involvement of EPC paging. Interestingly, by comparing the subfigures it can also be seen that Strawman performs worse for smaller packets. This is because smaller packet leads to higher packet rate while saturating the link, which in turn implies higher page fault ratio. For 600 Kflows, LightBox attains 3.5×-30× speedup over the Strawman.

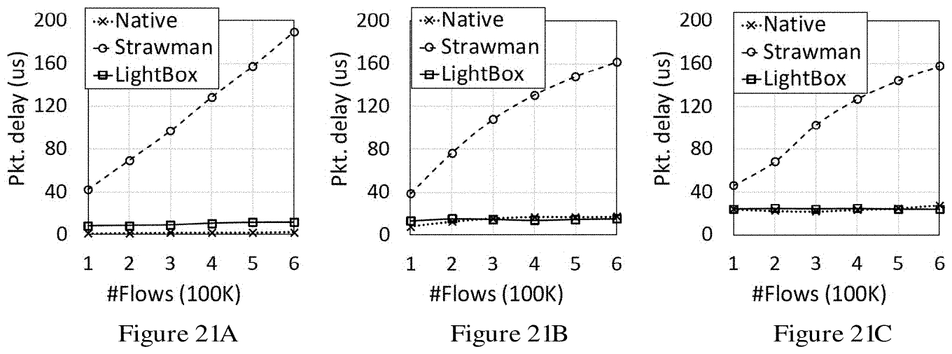

FIG. 21A to 21C show the results for lwIDS. FIGS. 21A to 21C present similar results for lwIDS. Here, the performance of Strawman is further degraded, since lwIDS has larger flow state size than PRADS and its memory footprint exceeds 550 MB even when tracking only 100K flows. For 64 B packet, LightBox introduces 6-8 μs packet delay (4-5× to native) because the state management dominates the whole processing; nonetheless, it still outperforms Strawman by 5-16×. For larger packets, the network function itself becomes dominant and the overhead of LightBox over Native is reduced, as shown in FIGS. 21B and 21C.

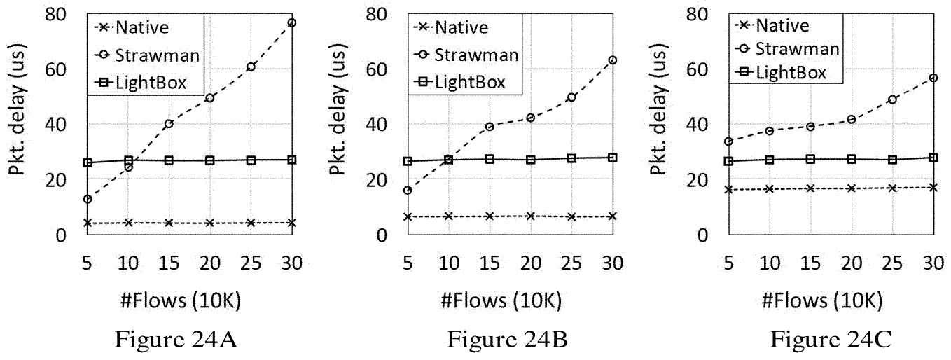

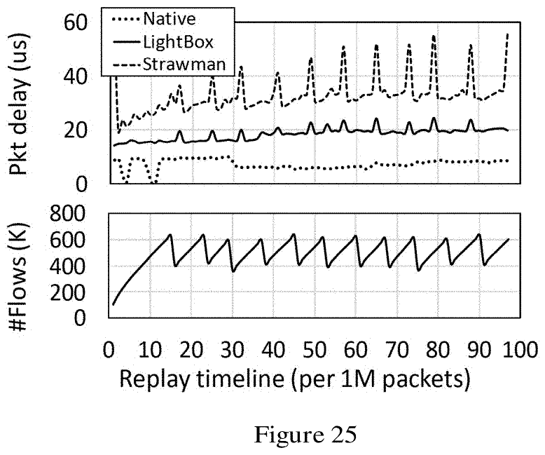

FIG. 24A to 24C show the results for mIDS. Among the three case-study middleboxes, mIDS is the most complicated one with the largest flow state. Here, the testbeds can scale to 300K concurrent connections. For each connection mIDS will track two flows, one for a direction, and allocate memory accordingly. But since the trivial ACK packets from the server to clients are filtered out, this example still counts only one flow per connection. FIG. 24A to 24C show that the performance of mIDS's three variants follows similar trends as in previous middleboxes: Native and LightBox are insensitive to the number of concurrent flows; conversely, the overhead of Strawman grows as more flows are tracked. But in contrast to previous cases, now the overhead of LightBox over Native becomes notable. This is explained by mIDS's large flow state size, i.e., 11.4 KB, which leads to the substantial cost of encrypting/decrypting and copying states. Besides, it has been found that for each packet, in addition to its own flow, mIDS will also access the paired flow, doubling the cost of the flow tracking design. Nonetheless, it can be seen that the gap is closing towards larger packet size, as the network function processing itself weighs in.

### 5.3.2 Real Trace

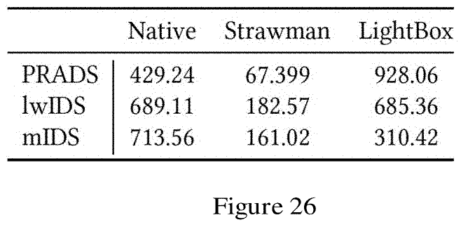

Next, the middlebox performance is investigated with respect to the real CAIDA trace. The trace is loaded by the gateway and replayed to the middlebox for processing. Again, the data points are collected for every 1M packets. Packets of unsupported types are filtered out so only 97 data points are collected for each case. Since L2 headers are stripped in the CAIDA trace, the packet parsing logic is adjusted accordingly for the middleboxes. Yet another important factor for real trace is the flow timeout setting. The timeout is carefully set so inactive flows are purged well in time, lest excessive flows overwhelm the testbeds. Here, the timeout for PRADS, lwIDS, and mIDS are set to 60, 30, and 15 seconds, respectively. The table in FIG. 26 lists the overall throughput of relaying the trace.

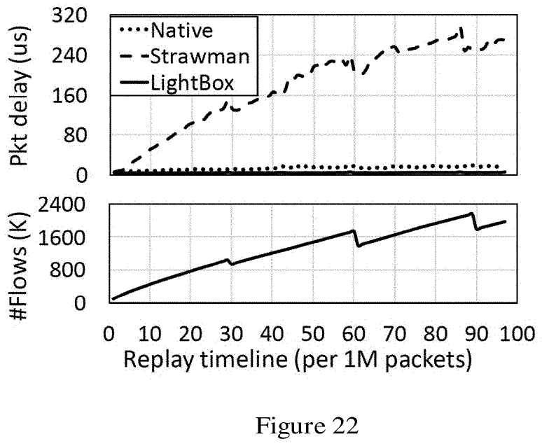

FIG. 22 shows the results for PRADS. As shown in FIG. 22, the packet delay of Strawman grows with the number of flows; it needs about 240 μs to process a packet when there are 1.6M flows. In comparison, LightBox maintains low and stable delay (around 6 μs) throughout the test. A bit surprisingly, it even edges over the native processing as more flows are tracked, attributed to an inefficient chained hashing design used in the native implementation. This highlights the importance of efficient flow lookup in stateful middleboxes.

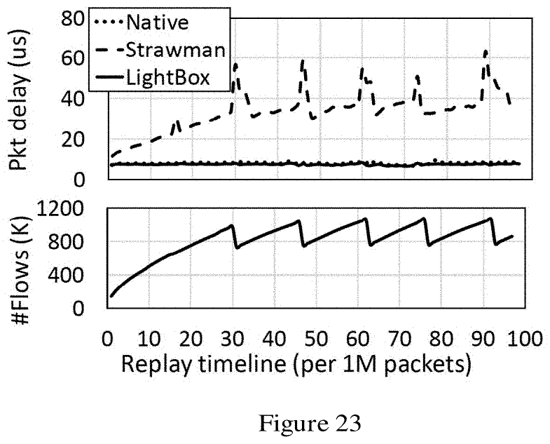

FIG. 23 shows the results for lwIDS. As shown in FIG. 23, compared with PRADS, the number of concurrent flows tracked by lwIDS decreases, as shown in FIG. 17. This is due to the halved timeout and the more aggressive strategy used for flow deletion: a flow is removed when a FIN or RST flag is received, and TIME_WAIT event is not handled. It can be seen that with fewer flows, Strawman still incurs remarkable overhead, while the difference between LightBox and Native is indistinguishable.

FIG. 24 shows the results for mIDS. The case for mIDS is tricky. Its current implementation of flow timeout seems not to be fully working, so the related code is replaced with the logic of checking all flows for expiration every timeout interval. Some modifications are also made to ensure that the packet formats and abnormal packets in the real trace can be properly processed. FIG. 24 shows the test results. There is again a large gap between Strawman and Native. Yet, as in the controlled settings, there is some moderate gap between LightBox and Native, due to the large state and double flow tracking design.

### 6. System/Hardware

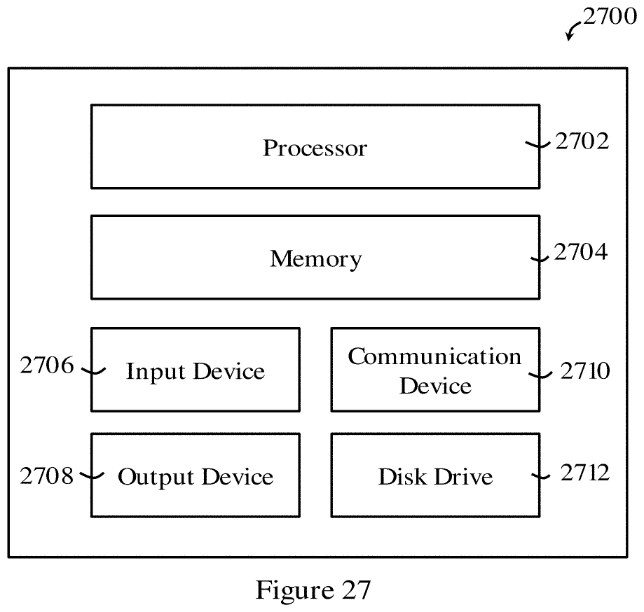

Referring to FIG. 27, there is shown a schematic diagram of an exemplary information handling system 2700 that can be used as a server or other information processing systems to implement any of the above embodiments of the invention. For example, the information handling system 2700 may be any of the computing devices, and/or can provide any of the modules/devices/gateway/environment/cache/storage, through suitable combination or implementation of hardware and/or software. The information handling system 2700 may have different configurations, and it generally comprises suitable components necessary to receive, store, and execute appropriate computer instructions, commands, or codes. The main components of the information handling system 2700 are a processor 2702 and a memory 2704. The processor 2702 may be formed by one or more of: CPU, MCU, controllers, logic circuits, Raspberry Pi chip, digital signal processor (DSP), application-specific integrated circuit (ASIC), Field-Programmable Gate Array (FPGA), or any other digital or analog circuitry configured to interpret and/or to execute program instructions and/or to process data. The processor preferably supports SGX instructions such as Intel® SGX instructions. The processor can have any number of cores. The memory 2704 may include one or more volatile memory (such as RAM, DRAM, SRAM), one or more non-volatile unit (such as ROM, PROM, EPROM, EEPROM, FRAM, MRAM, FLASH, SSD, NAND, and NVDIMM), or any of their combinations. Preferably, the information handling system 2700 further includes one or more input devices 2706 such as a keyboard, a mouse, a stylus, an image scanner, a microphone, a tactile input device (e.g., touch sensitive screen), and an image/video input device (e.g., camera). The information handling system 2700 may further include one or more output devices 2708 such as one or more displays (e.g., monitor), speakers, disk drives, headphones, earphones, printers, 3D printers, etc. The display may include a LCD display, a LED/OLED display, or any other suitable display that may or may not be touch sensitive. The information handling system 2700 may further include one or more disk drives 212 which may encompass solid state drives, hard disk drives, optical drives, flash drives, and/or magnetic tape drives. A suitable operating system may be installed in the information handling system 2700, e.g., on the disk drive 2712 or in the memory 2704. The memory 2704 and the disk drive 2712 may be operated by the processor 2702. The information handling system 2700 also preferably includes a communication device 2710 for establishing one or more communication links (not shown) with one or more other computing devices such as servers, personal computers, terminals, tablets, phones, or other wireless or handheld computing devices. The communication device 2710 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. Preferably, the processor 2702, the memory 2704, and optionally the input devices 2706, the output devices 2708, the communication device 2710 and the disk drives 2712 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the information handling system 2700 shown in FIG. 2 is merely exemplary and different information handling systems 2700 with different configurations may be applicable in the invention.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

The various embodiments disclosed can provide unique advantages. The embodiment of LightBox provides an SGX-assisted secure middlebox system. The system includes an elegant in-enclave virtual network interface that is highly secure, efficient and usable. The virtual network interface allows convenient access to fully protected packets at line rate without leaving the enclave, as if from the trusted source network. The system also incorporates a flow state management scheme that includes data structures and algorithms optimized for the highly constrained enclave space. They together provide a comprehensive solution for deploying off-site middleboxes with strong protection and stateful processing, at near-native speed. Indeed, extensive evaluations presented above demonstrate that “LightBox”, with all security benefits, can achieve 10 Gbps packet I/O, and that with case studies on three stateful middleboxes, it can operate at near-native speed. The embodiments for facilitating data communication of a trusted execution environment can improve data communication security, e.g., for middlebox applications. The embodiments for facilitating data communication of a trusted execution environment provide efficient and safe and efficient data storage and retrieval means for operating middleboxes. Other advantages in terms of computing security, performance, and/or efficiency can be readily appreciated based on a full review of the disclosure and so will not be non-exhaustively presented here.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

It will be appreciated by persons skilled in the art that numerous variations and/or modifications may be made to the invention as shown in the specific embodiments without departing from the scope of the invention as broadly described. Various alternatives have been provided in the disclosure, including the summary section. The described embodiments of the invention should therefore be considered in all respects as illustrative, not restrictive.

For example, the above embodiment may be modified to support multi-threading. Many existing middleboxes utilize multi-threading to achieve high throughput. The standard parallel architecture used by them relies on receiver-side scaling (RSS) or equivalent software approaches to distribute traffic into multiple queues by flows. Each flow is processed in its entirety by one single thread without affecting the others. To achieve this effect in the invention, in some embodiments, etap can be equipped with an emulation of this network interface card feature to cater for multi-threaded middleboxes. With the emulation, multiple RX rings will be created by etap, and each middlebox thread is binded to one RX ring. The core driver will hash the 5-tuple to decide which ring to push a packet, and the poll driver will only read packets from the ring binded to the calling thread. As the number of rings increases, the size of each ring should be kept small to avoid excessive enclave memory consumption. RSS mechanism ensures that each flow is processed in isolation to others. For a multithreaded middlebox, each thread is assigned a separate set of flow_cache, lkup_table, and flow_store. There is no intersection between the sets, and thus all threads can perform flow tracking simultaneously without data racing. Note that compared to the single-threaded case, this partition scheme does not change memory usage in managing the same number of flows.

For example, the above embodiments may be implemented in a different service model. To clearly lay out the core designs of LightBox, the above disclosure has focused on a basic service model, i.e., a single middlebox, and a single service provider hosting the middlebox service. However, the invention is not limited to this but can support other scenarios.

One such scenario concern service function chaining. Sometimes multiple logical middleboxes are chained together to process network traffic, which is commonly referred to as service function chaining. Practical execution of a single stateful middlebox in the enclave is already a non-trivial task, let alone running multiple enclaved stateful middleboxes on the same machine, where severe performance issue is almost inevitable. To this end, in some embodiments, each middlebox is driven in the chain with a LightBox instance on a separate physical machine. Along the chain, one instance's etap will be simultaneously peered with previous and next instance's etap (or the etap-cli at the gateway). Now each etap's core driver will effectively forward the encrypted traffic stream to the next etap. This way, each middlebox in the chain can access packet at line rate and run at its full speed. Note that the secure bootstrapping should be adjusted accordingly. In particular, the network administrator needs to attest each LightBox, and provision it with proper peer information.

One such scenario concern disjoint service providers. Middlebox outsourcing may span a disjoint set of service providers. A primary one may provide the networking and computing platform, yet others (e.g., professional cybersecurity companies) can provide bespoke middlebox functions and/or processing rules. Such service market segmentation calls for finer control over the composition of the security services. The SGX attestation utility enables any participant of the joint service to attest enclaves on the primary service provider's platform. Therefore, they can securely provision their proprietary code/ruleset to a trusted bootstrapping enclave. The code is then compiled in the bootstrapping enclave, and together with the rules, provisioned to LightBox enclave.

1. A computer-implemented method for facilitating data communication of a trusted execution environment, the method comprising:
processing a plurality of data packets, each including respective metadata, to form a data stream including the plurality of data packets, the data stream being a single continuous data stream in application-layer; and
transmitting the data stream to or from a network interface module for the trusted execution environment.

2. The computer-implemented method of claim 1, wherein the data stream is encrypted.

3. The computer-implemented method of claim 1, wherein the metadata of each of the data packet includes respective packet size, packet count, and timestamp.

4. The computer-implemented method of claim 3, wherein each of the data packets further includes application payload and one or more packet headers.

5. The computer-implemented method of claim 1, wherein processing the plurality of data packets comprises encoding the plurality of data packets.

6. The computer-implemented method of claim 1, wherein processing the plurality of data packets comprises packing the plurality of data packets back-to-back to form the data stream.

7. The computer-implemented method of claim 1, wherein transmitting the data stream comprises:
transmitting the data stream from a gateway to the network interface module via a communication channel arranged between the gateway and the network interface module; and/or
transmitting the data stream from the network interface module to a gateway via a communication channel arranged between the gateway and the network interface module.

8. The computer-implemented method of claim 7, further comprising:
transmitting one or more heartbeat packets from the gateway to the network interface module via the communication channel.

9. The computer-implemented method of claim 1, wherein the trusted execution environment comprises a middlebox module implemented in the trusted execution environment, and the network interface module is arranged to be in data communication with the middlebox module.

10. The computer-implemented method of claim 9, wherein the network interface module is initialized or arranged at least partly in the trusted execution environment.

11. The computer-implemented method of claim 10, wherein the trusted execution environment includes a Software Guard Extension (SGX) enclave.

12. The computer-implemented method of claim 11, wherein the trusted execution environment is initialized or provided using one or more processors that support SGX instructions.

13. The computer-implemented method of claim 9, wherein the network interface module includes a core driver arranged in the trusted execution environment, the core driver is arranged to receive and process the data stream.

14. The computer-implemented method of claim 13, wherein the core driver is further arranged to maintain a clock module in the trusted execution environment.

15. The computer-implemented method of claim 14, further comprising:
including a timestamp in each of the data packets prior to transmission of the data stream to the network interface module.

16. The computer-implemented method of claim 15, further comprising:
comparing, using the core driver, the timestamp in the received data packet with a clock in the clock module; and
updating the clock module based on the comparison.

17. The computer-implemented method of claim 16, wherein the network interface module further includes:
a poll driver arranged in the trusted execution environment, and operably connected with the core driver and with the middlebox module, the poll driver is arranged to enable the middlebox module to access data packets in the data stream received at the network interface module.

18. The computer-implemented method of claim 17, wherein the network interface module further includes:
a receiver repository arranged in the trusted execution environment and arranged between the core driver and the poll driver, the receiver repository is arranged to hold packet data received at the network interface module; and
a transmission repository arranged in the trusted execution environment and arranged between the core driver and the poll driver, the transmission repository is arranged to hold packet data to be transmitted out of the network interface module.

19. The computer-implemented method of claim 17, wherein the poll driver is arranged to operate in a blocking mode, in which a packet is guaranteed to be read or written, and a non-blocking mode.

20. The computer-implemented method of claim 18, further comprising:
synchronizing the receiver repository and the transmission repository.

21. The computer-implemented method of claim 18, wherein the network interface module further includes:
a buffer module arranged outside the trusted execution environment and arranged between the core driver and the gateway, the buffer module is arranged to hold a plurality of records.

22. A system for facilitating data communication of a trusted execution environment, the system comprising:
one or more processors arranged to:
process a plurality of data packets, each including respective metadata, to form a data stream including the plurality of data packets, wherein the data stream is a single continuous data stream in application-layer; and
facilitate transmission of the data stream to or from a network interface module for the trusted execution environment.

23. The system of claim 22, wherein the metadata of each of the data packet includes respective packet size, packet count, and timestamp.

24. The system of claim 22, wherein the one or more processors are arranged to encode the plurality of data packets.

25. The system of claim 22, wherein the one or more processors are arranged to pack the plurality of data packets back-to-back to form the data stream.

26. The system of claim 22, wherein the one or more processors are arranged to provide a gateway arranged to communicate with the network interface module via a communication channel.

27. The system of claim 22, wherein the one or more processors are arranged to provide the network interface module, the network interface module is arranged to communicate with a gateway via a communication channel.

28. The system of claim 26, wherein the one or more processors are arranged to:
facilitate transmission of one or more heartbeat packets from the gateway to the network interface module via the communication channel.

29. The system of claim 22, wherein the trusted execution environment comprises a middlebox module implemented in the trusted execution environment, and the network interface module is arranged to be in data communication with the middlebox module.

30. The system of claim 29, wherein the network interface module is initialized or arranged at least partly in the trusted execution environment.

31. The system of claim 30, wherein the trusted execution environment includes a Software Guard Extension (SGX) enclave.

32. The system of claim 30, wherein the trusted execution environment is initialized or provided using one or more processors.

33. The system of claim 29, wherein the network interface module includes a core driver arranged in the trusted execution environment, the core driver is arranged to receive and process the data stream.

34. The system of claim 33, wherein the core driver is further arranged to maintain a clock module in the trusted execution environment.

35. The system of claim 34, wherein the one or more processors are arranged to include a timestamp in each of the data packets prior to transmission of the data stream to the network interface module.

36. The system of claim 35, wherein the core driver is arranged to compare the timestamp in the received data packet with a clock in the clock module and update the clock module based on the comparison.

37. The system of claim 36, wherein the network interface module further includes:
a poll driver arranged in the trusted execution environment, and operably connected with the core driver and with the middlebox module, the poll driver is arranged to enable the middlebox module to access data packets in the data stream received at the network interface module.

38. The system of claim 36, wherein the poll driver is arranged to operate in a blocking mode, in which a packet is guaranteed to be read or written, and a non-blocking mode.

39. A network interface module for facilitating data communication of a trusted execution environment, the network interface module is arranged to communicate with a gateway via a communication channel, the network interface module comprising:
a core driver arranged in the trusted execution environment, the core driver is arranged to receive and process a data stream received from the gateway via the communication channel.

40. The network interface module of claim 39, wherein the core driver is further arranged to maintain a clock module in the trusted execution environment.

41. The network interface module of claim 40, wherein the core driver is arranged to compare a timestamp included in each of the received data packet with a clock in the clock module and to update the clock module based on the comparison.

42. The network interface module of claim 39, wherein the trusted execution environment comprises a middlebox module implemented in the trusted execution environment, and the network interface module is arranged to be in data communication with the middlebox module.

43. The network interface module of claim 42, wherein the network interface module is initialized or arranged at least partly in the trusted execution environment.

44. The network interface module of claim 43, wherein the trusted execution environment includes a Software Guard Extension (SGX) enclave.

45. The network interface module of claim 43, wherein the trusted execution environment is initialized or provided using one or more processors.

46. The network interface module of claim 42, wherein the network interface module further includes:
a poll driver arranged in the trusted execution environment, and operably connected with the core driver and with the middlebox module, the poll driver is arranged to enable the middlebox module to access data packets in the data stream received at the network interface module.

47. The network interface module of claim 46, wherein the network interface module further includes:
a receiver repository arranged in the trusted execution environment and arranged between the core driver and the poll driver, the receiver repository is arranged to hold packet data received at the network interface module; and
a transmission repository arranged in the trusted execution environment and arranged between the core driver and the poll driver, the transmission repository is arranged to hold packet data to be transmitted out of the network interface module.

48. The network interface module of claim 46, wherein the poll driver is arranged to operate in a blocking mode, in which a packet is guaranteed to be read or written, and a non-blocking mode.

49. The network interface module of claim 47, wherein the core driver and/or the poll driver are arranged to synchronize the receiver repository and the transmission repository.

50. The network interface module of claim 47, wherein the network interface module further includes:
a buffer module arranged outside the trusted execution environment and arranged between the core driver and the gateway, the buffer module is arranged to hold a plurality of records.
